(19) United States
(12) Patent Application Publication
(10) Pub. No.: US 2022/0358346 A1
(43) Pub. Date: Nov. 10, 2022

(54) SYSTEMS, METHODS, AND MEDIA FOR GENERATING AND USING SPIKING NEURAL NETWORKS WITH IMPROVED EFFICIENCY

(71) Applicant: Wisconsin Alumni Research Foundation, Madison, WI (US)

(72) Inventors: Mohit GUPTA, Madison, WI (US); Matthew DUTSON, Madison, WI (US)

(21) Appl. No.: 17/246,219

(22) Filed: Apr. 30, 2021

(51) Int. Cl. G06N 3/04; G06N 3/08

(52) U.S. Cl. CPC G06N 3/049; G06N 3/08; G06N 3/0481

(57) ABSTRACT

In accordance with some embodiments, systems, methods, and media for generating and using spiking neural networks with improved efficiency are provided. In some embodiments, a method comprises: receiving image data; providing the image data to a trained spiking neural network (SNN), the SNN comprising a plurality of neurons, each of the plurality of neurons associated with a respective initialization value V₀ of a plurality of initialization values, wherein a first layer of the trained SNN comprises a first subset of the plurality of neurons, and a second layer of the trained SNN comprises a second subset of the plurality of neurons, and wherein a mean of the plurality of initialization values is about 0.5, and a standard deviation of the initialization values is at least 0.05; receiving output from the trained SNN at a time step τ, wherein the output is based on activations of neurons in an output layer of the trained SNN, and wherein τ is in a range of 1 to T; and classifying the image data based on output of the trained SNN at time step τ.

### CROSS-REFERENCE TO RELATED APPLICATIONS

N/A

### STATEMENT REGARDING FEDERALLY SPONSORED RESEARCH

N/A

### BACKGROUND

In recent years, improvements in computer vision tasks have focused on improving accuracy. For example, over the past decade, the computer vision community has largely embraced an “accuracy first” philosophy in which “state-of-the-art” usually implies achieving the highest accuracy for a particular task. However, improved accuracy for a particular task may not be useful practically if the task cannot be performed quickly (e.g., with low latency), or if the amount of power expended to perform the task is relatively high.

Accordingly, new systems, methods, and media for generating spiking neural networks with improved efficiency are desirable.

### SUMMARY

In accordance with some embodiments of the disclosed subject matter, systems, methods, and media for generating and using spiking neural networks with improved efficiency are provided.

In accordance with some embodiments of the disclosed subject matter, a method for using a spiking neural network with improved efficiency is provided, the method comprising: receiving image data; providing the image data to a trained spiking neural network (SNN), the SNN comprising a plurality of neurons, each of the plurality of neurons associated with a respective initialization value V₀ of a plurality of initialization values, wherein a first layer of the trained SNN comprises a first subset of the plurality of neurons, and a second layer of the trained SNN comprises a second subset of the plurality of neurons, and wherein a mean of the plurality of initialization values is about 0.5, and a standard deviation of the initialization values is at least 0.05; receiving output from the trained SNN at a time step τ, wherein the output is based on activations of neurons in an output layer of the trained SNN, and wherein τ is in a range of 1 to T; and performing a computer vision task associated with the image data based on output of the trained SNN at time step τ.

In some embodiments, method of claim 1, the output is indicative of a neuron in the output layer that had the most activations up to time τ.

In some embodiments, the computer vision task comprises classification of the image data, and the neuron in the output layer that had the most activations up to time step τ corresponds to a first class of a plurality of classes.

In some embodiments, the method further comprises: receiving output from the trained SNN at a time step τ′ subsequent to time step τ; and performing the computer vision task based on output of the trained SNN at step time τ′.

In some embodiments, the image data comprises an array of pixels each associated with a value, and providing the image data to the trained SNN comprises: generating, for each pixel, a spike train based on the value associated with the pixel, wherein spikes are generated at a rate that is proportional to the value associated with the pixel; and providing, to each neuron of a plurality of neurons in an input layer of the trained SNN, a spike train associated with a respective pixel of the plurality of pixels.

In some embodiments, the image data comprises a plurality of spike streams generated by an imaging device.

In some embodiments, the imaging device comprises a light detection and ranging (LiDAR) device.

In some embodiments, the trained SNN was generated based on a trained analog neural network (ANN).

In some embodiments, the ANN was trained using a loss function L_{ANN} and the ANN was refined using a penalized loss function L′_{ANN} that included L_{ANN} and one or more penalized terms.

In some embodiments, the penalized loss function L′_{ANN} is represented by the relationship: L′_{ANN}=L_{ANN}+λₐLₐ+λₛLₛ, where Lₐ is an activation loss term based on β values associated with batch normalization layers of the trained ANN, Lₛ is a synaptic sparsity loss term based on weights of the trained ANN, and λₐ and λₛ are penalty values.

In some embodiments, the method further comprises: refining the trained SNN using a loss function L_{SNN}.

In some embodiments, the loss function L_{SNN} includes an accuracy term, a latency term, and a power consumption term.

In some embodiments, the loss function L_{SNN} is represented by the relationship: L_{SNN}=λ_{M}M+λ_{L}b_{L}+λ_{P}b_{P} where M is a minimum error 1−aₜ, aₜ represents an accuracy of the trained SNN at a particular time step, b_{L} represents a latency of the trained SNN, bₚ represents power consumption of the trained SNN, and λ_{M}, λ_{L}, and λ_{P} are penalty values.

In some embodiments, refining the SNN further comprises: applying, to each of the plurality of neurons, a scaling factor ηⱼ, wherein H is a set of scaling factors for the plurality of neurons; providing first labeled training data to the trained SNN; receiving first output from the trained SNN for the first labeled training data; calculating a first loss based on the first labeled training data and the first output from the trained SNN using the loss function L_{SNN}; adjusting values of the scaling factors in H based on the loss; applying the adjusted scaling factors to the plurality of neurons of the trained SNN; providing second labeled training data to the trained SNN; receiving second output from the trained SNN for the second labeled training data; and calculating a second loss based on the second labeled training data and the second output from the trained SNN using the loss function L_{SNN}.

In some embodiments, refining the SNN further comprises: setting an initialization value V₀ for each of the plurality of neurons, wherein I includes a set of initialization values; providing first labeled training data to the trained SNN; receiving first output from the trained SNN for the first labeled training data; calculating a first loss based on the first labeled training data and the first output from the trained SNN using the loss function L_{SNN}; adjusting values of the initialization values in I based on the loss; applying the adjusted initialization values to the plurality of neurons of the trained SNN; providing second labeled training data to the trained SNN; receiving second output from the trained SNN for the second labeled training data; and calculating a second loss based on the second labeled training data and the second output from the trained SNN using the loss function L_{SNN}.

In some embodiments, the ANN is a convolutional neural network (CNN).

In some embodiments, an output Θ_{j,t} of a neuron j of the plurality of neurons is represented by the relationship:

$${Θ}_{j , t} = \{ \begin{matrix}1 & if {V}_{j , t} \geq 1 \\ 0 & else\end{matrix} ,$$

where j represents a neuron index, t represents a current time step, and V_{j,t} represents a neuron membrane potential at time step t, V_{j,0} is the initialization value of neuron j, wherein the neuron membrane potential V_{j,t} of neuron j is represented by the relationship: V_{j,t}=V_{j,t-1}−Θ_{j,t-1}+I_{j,t}, where I_{j,t} represents an incoming current at time t, and the incoming current I_{j,t} is represented by the relationship: I_{j,t}=s_{j,t}·wⱼ+bⱼ, where s_{j,t} represents a binary-valued vector of incoming spikes at time step t, including one entry for each incoming synapse to neuron j, wⱼ represents a vector of synaptic weights associated with incoming synapses, and bⱼ represents a neuron bias of neuron j.

In accordance with some embodiments of the disclosed subject matter, a system for using a spiking neural network with improved efficiency is provided, the system comprising: at least one processor that is configured to: receive image data; provide the image data to a trained spiking neural network (SNN), the SNN comprising a plurality of neurons, each of the plurality of neurons associated with a respective initialization value V₀ of a plurality of initialization values, wherein a first layer of the trained SNN comprises a first subset of the plurality of neurons, and a second layer of the trained SNN comprises a second subset of the plurality of neurons, and wherein a mean of the plurality of initialization values is about 0.5, and a standard deviation of the initialization values is at least 0.05; receive output from the trained SNN at a time step t, wherein the output is based on activations of neurons in an output layer of the trained SNN, and wherein t is in a range of 1 to T; and perform a computer vision task associated with the image data based on output of the trained SNN at time step t.

In some embodiments, the at least one processor comprises a neuromorphic processor.

In some embodiments, the system further comprises: an image data source in communication with the at least one processor, the image data source comprising an array of single-photon avalanche photodiodes (SPADs); and wherein the at least one processor that is further configured to: receive the image data from the image data source.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 shows an example of a system for generating and using spiking neural networks with improved efficiency in accordance with some embodiments of the disclosed subject matter.

FIG. 2 shows an example of hardware that can be used to implement a data source, a computing device, and a server, shown in FIG. 1 in accordance with some embodiments of the disclosed subject matter.

FIG. 3A shows a conceptual example of computations at various layers of a trained analog neural network (ANN) and prediction accuracy of the ANN for a particular set of synchronous inputs at various points in time after the inputs are provided.

FIG. 3B shows a conceptual example of computations at various layers of a trained spiking neural network (SNN) and prediction accuracy of the SNN for a particular set of asynchronous inputs at various points in time as the inputs are provided.

FIG. 3C shows a conceptual example of computations at various layers of a trained SNN refined using techniques described herein and prediction accuracy of the SNN for the particular set of asynchronous inputs at various points in time as the inputs are provided.

FIG. 4A shows an example of a topology of spiking neural network (SNN) that can be enhanced using mechanisms described herein in accordance with some embodiments of the disclosed subject matter.

FIG. 4B shows an example of scaling of incoming weights and outgoing weights of a neuron in an SNN that can be used to enhance efficiency of an SNN using mechanisms described herein in accordance with some embodiments of the disclosed subject matter.

FIG. 4C shows an example of hardware that can be used to implement an SNN trained and refined using techniques described herein.

FIG. 5 shows an example of a flow for training, refining, and using SNNs with improved efficiency in accordance with some embodiments of the disclosed subject matter.

FIG. 6 shows an example of a process for training, refining, and using SNNs with improved efficiency to classify image data in accordance with some embodiments of the disclosed subject matter.

FIG. 7 shows an example of efficiency improvements that can be realized using mechanisms described herein for enhancing SNN efficiency in accordance with some embodiments of the disclosed subject matter.

FIG. 8 shows another example of efficiency improvements that can be realized using mechanisms described herein for enhancing SNN efficiency in accordance with some embodiments of the disclosed subject matter.

FIG. 9A shows an example illustrating an effect of bath normalization on ANN activation sparsity that can be used in connection with mechanisms described herein for enhancing SNN efficiency in accordance with some embodiments of the disclosed subject matter.

FIG. 9B shows an example illustrating activation maps for the two batch normalization values of FIG. 9A.

FIG. 10 shows examples of efficiency improvements realized using mechanisms described herein to enhance SNNs derived from various ANN model architectures.

FIG. 11 shows example of efficiency improvements in multiple measures of efficiency realized using various mechanisms described herein to enhance SNNs derived from a convolutional MNIST model.

### DETAILED DESCRIPTION

In accordance with various embodiments, mechanisms (which can, for example, include systems, methods, and media) for generating and using spiking neural networks with improved efficiency are provided.

In many computer vision tasks, latency and power use are important factors that can impact performance of a computer vision system. For example, real time applications, such as mixed reality (MR), augmented reality (AR), virtual reality (VR), embodied perception, and autonomous navigation, computer vision tasks (e.g., image classification, scene measurement, etc.) may require low latency to operate successfully. Additionally, many real time applications may be performed by a power constrained system (e.g., a battery powered system). In many computer vision tasks, frame-based, floating-point inferences may incur unavoidable temporal delays and high energy costs, making such techniques ill-suited for resource-constrained real-time applications. For example, as deep learning applications have matured, new axes in the performance space have begun to emerge for new classes of applications (e.g., embodied perception, autonomous navigation, AR, MR, and VR) where latency and power consumption may be as important as accuracy. In such applications, it is important to consider not just overall accuracy, but a notion of streaming accuracy indicative of whether the computer vision task is performed with sufficient accuracy while adhering to a set of time and power constraints.

In some embodiments, mechanisms described herein can improve the efficiency of computer-vision tasks using spike-based streaming perception techniques, which can integrate latency and accuracy, resulting in a smooth latency-accuracy trade-off curve (e.g., a Pareto optimal trade-off curve). Mechanisms described herein can utilize spiking neural networks (SNNs), which perform inference via temporal sequences of discrete spikes rather than floating-point values used in conventional floating point neural networks (FNNs). As described below, in an SNN, a neuron can be activated when a “membrane potential” reaches a threshold, and the neuron can output a spike when it is activated (e.g., as described below in connection with EQ. (3)). In an FNN, nodes can activated each time an input is received (e.g., by calculating a weighted sum of inputs from nodes in a previous layer, adding a bias, and passing through an activation function), and the output associated with a node can be represented as a floating point value. Note that FNNs are described herein as analog neural networks (ANN), as nodes in a FNNs can output values that essentially analog (e.g., values that vary continuously). However, both FNNs and SNNs are types of artificial neural networks.

In general, SNNs can operate in an asynchronous and distributed fashion, facilitating relatively rapid, low-power inferences. Mechanisms described herein can leverage unique characteristics of SNNs to reduce latency and power consumption by 1-2 orders of magnitude.

Mechanisms described herein can facilitate spike-based streaming perception, an approach that can integrate latency and accuracy into a single evaluation space. In SNNs artificial neurons can exchange information via temporal sequences of discrete spikes, in contrast with the continuous-valued activations in conventional ANNs. Each spike denotes an event, and information is encoded in the frequency and timing of spikes.

Through asynchronous spike-based computation SNNs can generate predictions more quickly than an ANN with a similar number of layers (e.g., SNNs can facilitate pseudo-instantaneous information processing) and can increase the accuracy of predictions as more data is received, which can lead to a smooth accuracy-latency tradeoff (e.g., a Pareto optimal curve archetypical of “anytime algorithms”). For example, a robot navigating in a dynamic environment often needs to make decisions quickly (e.g., to avoid obstacles). Such situations require short reaction times often inaccessible to the synchronous processing of ANN-based perception. Deep SNNs can provide earlier (though potentially less precise) estimates, which can improve when given more processing time. These properties can make SNNs suitable for both processes that benefit from fast decision-making and slower, more deliberate processes, such as long-term path planning. Such hierarchical fast and slow reasoning is thought to be similar to human decision-making processes, and can pave the way for new classes of dynamic control techniques where Pareto optimal operating points are identified in-situ, at the time-granularity of individual spikes.

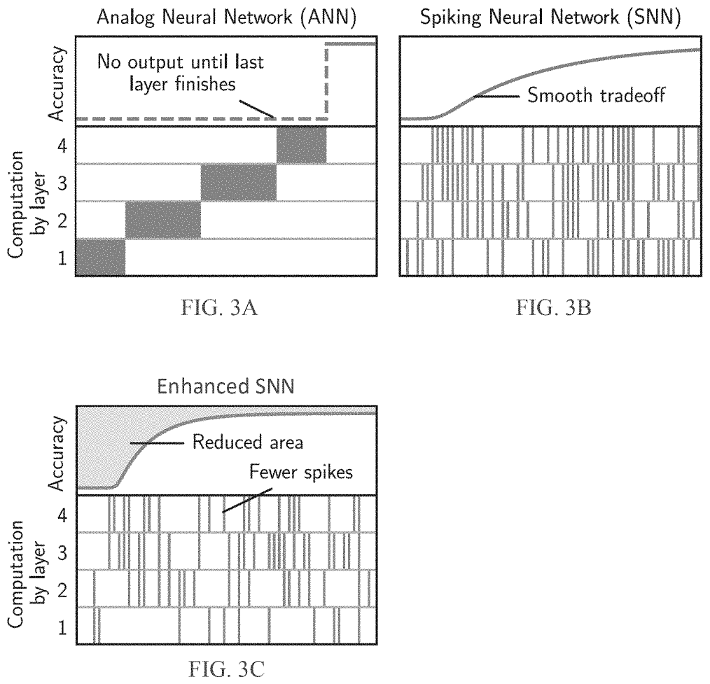

The discrete nature of asynchronous spikes provided as input to SNNs can result in non-differentiable network dynamics, precluding the use of gradient-based training techniques that are commonly used with ANNs. One workaround to this potential limitation is to first train an ANN (e.g., using conventional gradient-based training techniques), and mapping the ANNs weights to an equivalent SNN. Such ANN to SNN conversion can generate SNNs that are highly accurate, but the resulting models can exhibit inefficient firing patterns. In some embodiments, mechanisms described herein can be used to alter the weights, sparsity, and/or initialization conditions to improve the efficiency of SNNs, for example, via reduced latency and/or reduced power consumption in a converted SNN. Such enhancements can push the Pareto optimal tradeoff curve of upward (e.g., as shown in FIGS. 3B and 3C, described below).

In some embodiments, SNN neuron firing rates can be scaled at the neuron level without changing the underlying network representation, which can result in a network that exhibits improved accuracy, reduced latency, and/or reduced power consumption.

As described below in connection with FIGS. 3B and 3C, due to the asynchronous propagation of spikes, SNNs display transient dynamics in which firing rates (and thus, accuracy) evolves over time before achieving steady-state behavior. In some embodiments, transient dynamics of an SNN can be adjusted by varying the initialization of the model. For example, mechanisms described herein can be used to select an initialization that can dramatically reduce latency.

In general, SNNs can exploit weight and activation sparsity, because SNNs generate inferences in terms of single spikes. In some embodiments, mechanisms described herein can adjust the sparsity of the model representation of an SNN (e.g., during training of an ANN from which the SNN is generated), which can substantially reduce computation and power consumption without significantly impacting accuracy.

Note that although mechanisms described herein are generally described in connection with the task of image classification on single, relatively static scenes (e.g., over the time period over which the output of the SNN settles at a steady state). However, this is merely an example, and mechanisms described herein can be used to perform other tasks, such as object detection, segmentation, and tracking, and can be used to implement SNNs trained to evaluate time-varying data (e.g., video data).

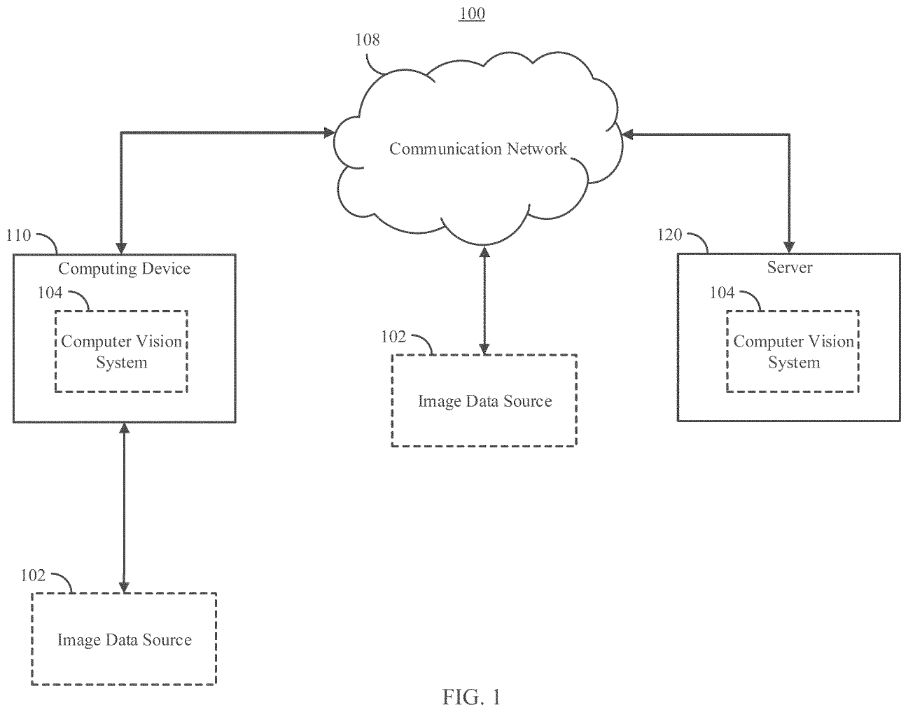

FIG. 1 shows an example 100 of a system for generating and using spiking neural networks with improved efficiency in accordance with some embodiments of the disclosed subject matter. As shown in FIG. 1, a computing device 110 can receive image data from an image data source 102. In some embodiments, computing device 110 can execute at least a portion of a computer vision system 104 to perform a computer vision task, such as image classification, object detection, image segmentation, object tracking, and/or any other suitable computer vision task.

In some embodiments, computing device 110 can execute at least a portion of a computer vision system 104 to use an SNN to perform a computer vision task with improved efficiency (e.g., with reduced latency and/or reduced power consumption).

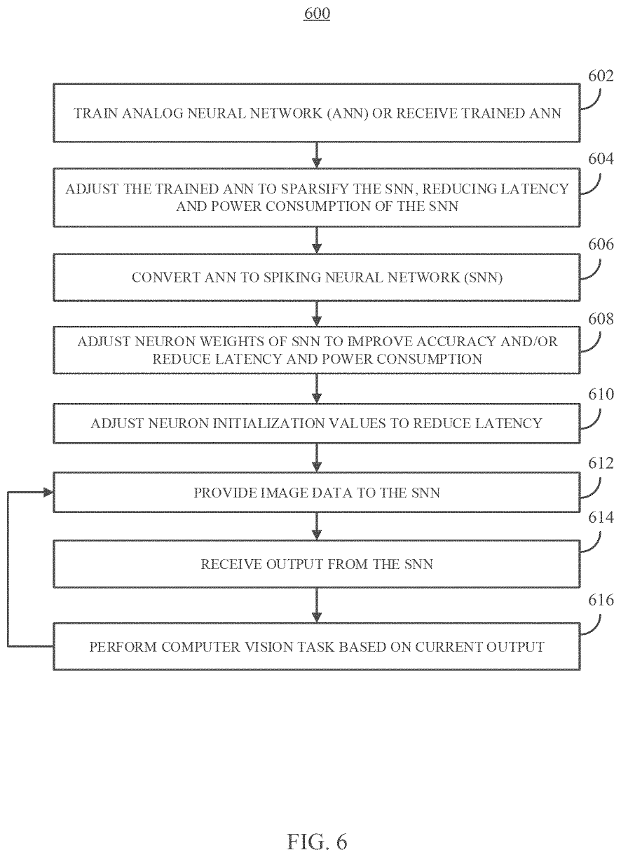

Additionally or alternatively, in some embodiments, computing device 110 can communicate data received from image data source 102 to a server 120 over a communication network 108, which can execute at least a portion of computer vision system 104. In such embodiments, server 120 can return information to computing device 110 (and/or any other suitable computing device) indicative of an output of one or more SNNs used to implement computer vision system 104 to take an action based on an outcome of the computer vision task. In some embodiments, computer vision system 104 can execute one or more portions of process 600 described below in connection with FIG. 6.

In some embodiments, computing device 110 and/or server 120 can be any suitable computing device or combination of devices, such as a desktop computer, a laptop computer, a smartphone, a tablet computer, a wearable computer, a server computer, a virtual machine being executed by a physical computing device, etc.

In some embodiments, image data source 102 can be any suitable source of image data (e.g., asynchronously generated image data) and/or other data that can be used to evaluate characteristics of a physical environment of image data source 102. For example, image data source 102 can one or more digital cameras that generate and/or output color image data, monochrome image data, image data representing light from one or more wavelengths outside the visible spectrum (e.g., infrared (IR), near infrared (NIR), ultraviolet (UV), x-ray, etc.), two-dimensional image data, three-dimensional image data, any other suitable image data, or any suitable combination thereof. In a more particular example, image data source 102 can include an imaging device configured to detect arrival of individual photons (e.g., using avalanche photodiodes), such imaging devices described in U.S. patent application Ser. No. 16/844,899, filed Apr. 9, 2020, and titled “Systems, methods, and media for high dynamic range quanta burst imaging.” As another example, image data source 102 can be a light detection and ranging (LiDAR) device that generates and/or outputs data indicative of distance to one or more points in a physical environment of the LiDAR device (e.g., corresponding to one or more objects, surfaces, etc.). As yet another example, image data source 102 can be any other suitable device that can produce asynchronous image data.

In some embodiments, image data source 102 can be local to computing device 110. For example, image data source 102 can be incorporated with computing device 110 (e.g., computing device 110 can be configured as part of a device for capturing and/or storing image data). As another example, image data source 102 can be connected to computing device 110 by a cable, a direct wireless link, etc. Additionally or alternatively, in some embodiments, image data source 102 can be located locally and/or remotely from computing device 110, and can communicate image data to computing device 110 (and/or server 120) via a communication network (e.g., communication network 108).

In some embodiments, communication network 108 can be any suitable communication network or combination of communication networks. For example, communication network 108 can include a Wi-Fi network (which can include one or more wireless routers, one or more switches, etc.), a peer-to-peer network (e.g., a Bluetooth network), a cellular network (e.g., a 3G network, a 4G network, a 5G network, etc., complying with any suitable standard, such as CDMA, GSM, LTE, LTE Advanced, NR, etc.), a wired network, etc. In some embodiments, communication network 108 can be a local area network, a wide area network, a public network (e.g., the Internet), a private or semi-private network (e.g., a corporate or university intranet), any other suitable type of network, or any suitable combination of networks. Communications links shown in FIG. 1 can each be any suitable communications link or combination of communications links, such as wired links, fiber optic links, Wi-Fi links, Bluetooth links, cellular links, etc.

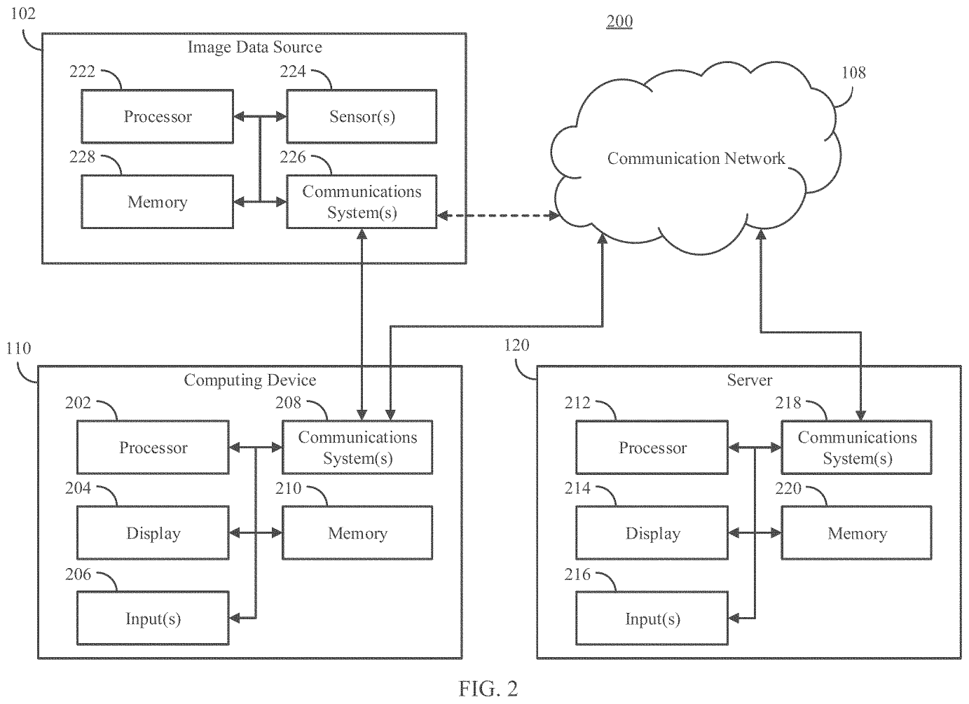

FIG. 2 shows an example 200 of hardware that can be used to implement image data source 102, computing device 110, and/or server 120 in accordance with some embodiments of the disclosed subject matter. As shown in FIG. 2, in some embodiments, computing device 110 can include a processor 202, a display 204, one or more inputs 206, one or more communication systems 208, and/or memory 210. In some embodiments, processor 202 can be any suitable hardware processor or combination of processors, such as a central processing unit (CPU), a graphics processing unit (GPU), an application specific integrated circuit (ASIC), a field-programmable gate array (FPGA), etc. In a particular example, processor 202 can be a neuromorphic processor or neuromorphic processors configured to implement neurons for an SNN using hardware level. As another more particular example, processor 202 can be implemented using conventional hardware configured to implement neurons for an SNN using firmware and/or software to simulate neurons. In some embodiments, display 204 can include any suitable display devices, such as a computer monitor, a touchscreen, a television, etc. In some embodiments, inputs 206 can include any suitable input devices and/or sensors that can be used to receive user input, such as a keyboard, a mouse, a touchscreen, a microphone, etc.

In some embodiments, communications systems 208 can include any suitable hardware, firmware, and/or software for communicating information over communication network 108 and/or any other suitable communication networks. For example, communications systems 208 can include one or more transceivers, one or more communication chips and/or chip sets, etc. In a more particular example, communications systems 208 can include hardware, firmware and/or software that can be used to establish a Wi-Fi connection, a Bluetooth connection, a cellular connection, an Ethernet connection, etc.

In some embodiments, memory 210 can include any suitable storage device or devices that can be used to store instructions, values, etc., that can be used, for example, by processor 202 to perform a computer vision task, to present content using display 204, to communicate with server 120 via communications system(s) 208, etc. Memory 210 can include any suitable volatile memory, non-volatile memory, storage, or any suitable combination thereof. For example, memory 210 can include random access memory (RAM), read-only memory (ROM), electronically-erasable programmable read-only memory (EEPROM), one or more flash drives, one or more hard disks, one or more solid state drives, one or more optical drives, etc. In some embodiments, memory 210 can have encoded thereon a computer program for controlling operation of computing device 110. For example, in such embodiments, processor 202 can execute at least a portion of the computer program to use an SNN(s) in the performance of one or more computer vision tasks, present content (e.g., images, information about an object included in image data, information about distances to one or more points in a scene, etc.), receive information and/or content from server 120, transmit information to server 120, etc. As another example, processor 202 can execute at least a portion of the computer program to implement computer vision system 104. As yet another example, processor 202 can execute at least a portion of process 600 described below in connection with FIG. 6.

In some embodiments, server 120 can include a processor 212, a display 214, one or more inputs 216, one or more communications systems 218, and/or memory 220. In some embodiments, processor 212 can be any suitable hardware processor or combination of processors, such as a CPU, a GPU, an ASIC, an FPGA, etc. In some embodiments, display 214 can include any suitable display devices, such as a computer monitor, a touchscreen, a television, etc. In some embodiments, inputs 216 can include any suitable input devices and/or sensors that can be used to receive user input, such as a keyboard, a mouse, a touchscreen, a microphone, etc.

In some embodiments, communications systems 218 can include any suitable hardware, firmware, and/or software for communicating information over communication network 108 and/or any other suitable communication networks. For example, communications systems 218 can include one or more transceivers, one or more communication chips and/or chip sets, etc. In a more particular example, communications systems 218 can include hardware, firmware and/or software that can be used to establish a Wi-Fi connection, a Bluetooth connection, a cellular connection, an Ethernet connection, etc.

In some embodiments, memory 220 can include any suitable storage device or devices that can be used to store instructions, values, etc., that can be used, for example, by processor 212 to present content using display 214, to communicate with one or more computing devices 110, etc. Memory 220 can include any suitable volatile memory, non-volatile memory, storage, or any suitable combination thereof. For example, memory 220 can include RAM, ROM, EEPROM, one or more flash drives, one or more hard disks, one or more solid state drives, one or more optical drives, etc. In some embodiments, memory 220 can have encoded thereon a server program for controlling operation of server 120. For example, in such embodiments, processor 212 can execute at least a portion of the server program to use an SNN(s) in the performance of one or more computer vision tasks, transmit content (e.g., images, information about an object included in image data, information about distances to one or more points in a scene, etc.) to a computing device (e.g., computing device 110), receive information and/or content from computing device 110, transmit information to computing device 110, etc. As another example, processor 212 can execute at least a portion of the computer program to implement computer vision system 104. As yet another example, processor 212 can execute at least a portion of process 600 described below in connection with FIG. 6.

In some embodiments, image data source 102 can include a processor 222, one or more sensors 224, one or more communications systems 226, and/or memory 228. In some embodiments, processor 222 can be any suitable hardware processor or combination of processors, such as a CPU, a GPU, an ASIC, an FPGA, etc. In some embodiments, sensor(s) 224 can be any suitable components to generate image data (e.g., asynchronously) representing a portion of a scene. For example, sensor(s) 224 can include a CMOS sensor, a CCD sensor, an array of single-photon avalanche diodes (SPADs), an array of jots (e.g., as described in U.S. patent application Ser. No. 16/844,899), a LiDAR sensor, etc. Although not shown, image data source 102 can include one or more light sources (e.g., a LiDAR light source, a light source for structured light imaging, a modulated light source for continuous time-of-flight imaging, etc.).

Note that, although not shown, image data source 102 can include any suitable inputs and/or outputs. For example, image data source 102 can include input devices and/or sensors that can be used to receive user input, such as a keyboard, a mouse, a touchscreen, a microphone, a trackpad, a trackball, hardware buttons, software buttons, etc. As another example, image data source 102 can include any suitable display devices, such as a computer monitor, a touchscreen, a television, etc., one or more speakers, etc.

In some embodiments, communications systems 226 can include any suitable hardware, firmware, and/or software for communicating information to computing device 110 (and, in some embodiments, over communication network 108 and/or any other suitable communication networks). For example, communications systems 226 can include one or more transceivers, one or more communication chips and/or chip sets, etc. In a more particular example, communications systems 226 can include hardware, firmware and/or software that can be used to establish a wired connection using any suitable port and/or communication standard (e.g., VGA, DVI video, USB, RS-232, etc.), Wi-Fi connection, a Bluetooth connection, a cellular connection, an Ethernet connection, etc.

In some embodiments, memory 228 can include any suitable storage device or devices that can be used to store instructions, values, image data, etc., that can be used, for example, by processor 222 to: control sensor(s) 224, and/or receive outputs from sensor(s) 224; generate image data; present content (e.g., images, a user interface, etc.) using a display; communicate with one or more computing devices 110; etc. Memory 228 can include any suitable volatile memory, non-volatile memory, storage, or any suitable combination thereof. For example, memory 228 can include RAM, ROM, EEPROM, one or more flash drives, one or more hard disks, one or more solid state drives, one or more optical drives, etc. In some embodiments, memory 228 can have encoded thereon a program for controlling operation of image data source 102. For example, in such embodiments, processor 222 can execute at least a portion of the program to generate image data, transmit information and/or content (e.g., image data) to one or more computing devices 110, receive information and/or content from one or more computing devices 110, transmit information and/or content (e.g., image data) to one or more servers 120, receive information and/or content from one or more servers 120, receive instructions from one or more devices (e.g., a personal computer, a laptop computer, a tablet computer, a smartphone, etc.), etc. As another example, processor 222 can execute at least a portion of the program to implement computer vision system 104. As yet another example, processor 222 can execute at least a portion of process 600 described below in connection with FIG. 6.

FIG. 3A shows a conceptual example of computations at various layers of a trained analog neural network (ANN) and prediction accuracy of the ANN for a particular set of synchronous inputs at various points in time after the inputs are provided. FIGS. 3B and 3C show conceptual examples of computations at various layers of a trained spiking neural network (SNN) and prediction accuracy of the SNN for a particular set of asynchronous inputs at various points in time as the inputs are provided, and computations and predication accuracy of an SNN enhanced using techniques described herein. FIG. 3D shows an example of hardware that can be used to implement an SNN trained and refined using techniques described herein.

As shown in FIG. 3A, in an ANN, processing proceeds one layer at a time, and no output is available until the final layer finishes processing. As shown in FIG. 3B, a conventional SNN can provide an output much earlier than the ANN, as inputs can propagate through the layers relatively quickly. The accuracy of the initial output is lower than the output of the ANN, however, as the SNN reaches a steady state, the accuracy improves to a similar level as the output provided by the ANN.

In some embodiments, mechanisms described herein can be used to shift the latency-accuracy curve toward lower latency, and can reduce power consumption by reducing the number of activations, while at least maintaining a similar steady state accuracy. As shown in FIG. 3C, mechanisms described herein can provide an initial output in about the same amount of time as the conventional SNN represented by FIG. 3B, and can increase in accuracy more quickly (e.g., reaching a similar steady state accuracy significantly sooner than the conventional SNN). Additionally, as shown in FIG. 3C, the number of spikes (representing neuron activations) can be reduced using mechanisms described herein, which can reduce the number of computations performed by the system, thereby having the potential to reduce power consumption.

In some embodiments, mechanisms described herein can have a greater impact on efficiency when implemented on neuromorphic hardware, such as chips based on the Loihi architecture developed by Intel, Corporation headquartered in Santa Clara, Calif. Neuromorphic hardware is still a relatively nascent technology, and limited access to such hardware has limited widespread adoption of SNNs for computer vision applications. As described below in connection with TABLES 1 and 2, mechanisms described herein were tested using an SNN simulator (sometimes referred to herein as SaRNN). The simulator was developed in connection with mechanisms described herein to demonstrate efficiency improvements that can be realized using mechanisms described herein. SaRNN is orders of magnitude faster than other SNN simulators, which facilitates simulation of SNNs with complexities that were previously infeasible. SaRNN also supports relatively simple mapping to neuromorphic platforms such as the Spinking Nueral Network Architecture (SpiNNaker) developed by the Advanced Processor Technologies Research Group (APT) at the Department of Computer Science, University of Manchester using the PyNN API made available via NeuralEnsemble(dot)org using the PyNN language described in Davison, et al., “PyNN: a common interface for neuronal network simulators,” Front. Neuroinform, 2:11 (2009).

As described above in connection with FIGS. 3B and 3C, mechanisms described herein can improve latency and reduce power consumption. The latency and power consumption of a trained SNN can be measured after training is completed. However, defining metrics that can be used to represent the latency and power consumption of an SNN can facilitate training and/or refinement of an SNN that is configured to improve those metrics (e.g., by including terms based on the metrics in the loss function).

Multiple metrics can be defined to attempt to quantify latency and power consumption of an SNN. For example, given the smooth latency-accuracy tradeoff curve shown in FIGS. 3B and 3C, a possible latency metric can be defined based on a measurement of the number of time steps required for the curve to cross a predetermined accuracy threshold. However, such a metric can be sensitive to the choice of threshold, and the result does not vary smoothly with network dynamics (e.g., a model can take 8 or 9 time steps to cross the threshold, but not 8.5 time steps).

In some embodiments, latency can be defined based on the area above the accuracy-time curve (shown shaded in FIG. 3C). In general, an SNN can generate an output (sometimes referred to herein as an inference) at each of T time steps. The accuracy of the SNN at each step can be represented by a value aₜ, such that the instantaneous accuracy at each time step can be represented by values a₁, a₂, . . . , a_{T} and a_{ANN} can represent the asymptotic ANN accuracy (e.g., the accuracy of the ANN prior to conversion). Latency can be represented by a metric referred to herein as L-briskness, which can be defined as a value b_{L}, where

b_{L}=Σₜ₌₁^{T}(a_{ANN}−aₜ). (1)

L-briskness can represent a comparison of the total error (over all time steps) to that of a model which immediately achieves maximum accuracy. Note that lower values of L-briskness correspond to lower latency, as lowering L-briskness corresponds to “lifting” the accuracy-latency curve shown in FIG. 3C such that the area above the curve is reduced (e.g., L-briskness for the SNN in FIG. 3C is higher than L-briskness for the SNN in FIG. 3B).

In some embodiments, power consumption can be defined based on number of synaptic events that occur at each of the T time steps. The number of synaptic events processed by the SNN at each step can be represented by a value et, such that the number of events at each time step can be represented by values e₁, e₂, . . . , e_{T}. Power consumption can be represented by a metric referred to herein as P-briskness, which can be defined as a value b_{P}, where

b_{L}=Σₜ₌₁^{T}(a_{ANN}−aₜ). (2)

Note that spiking events are represented in FIGS. 3B and 3C, but spiking events and synaptic evens, while related, are different events. When a neuron in the SNN spikes (sometimes referred to herein as a spiking event), one synaptic event is triggered for each of the outgoing synapses associated with the neuron. The metrics L-briskness and/or P-briskness are used herein to evaluate the efficiency of SNNs with different characteristics (e.g., number of neurons, parameters, weights, initialization values, etc.).

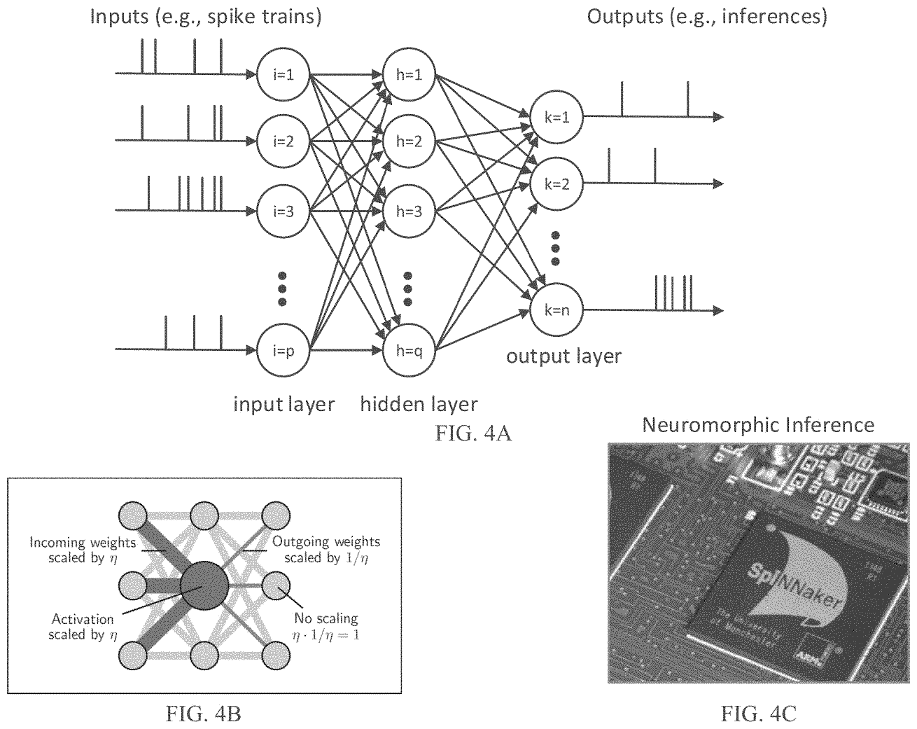

FIG. 4A shows an example of a topology of spiking neural network (SNN) that can be enhanced using mechanisms described herein in accordance with some embodiments of the disclosed subject matter. In generally, SNNs are structurally similar to many ANNs, with neurons connected by weighted synapses to form a network. SNN neurons can communicate by passing spikes (which is sometimes can referred to as “current” based on similarities to electrical current carried by synapses in the brain). Incoming current on a synapse can change a value associated with the neuron (which is sometimes referred to as the “membrane potential” (voltage) of a neuron), and may cause the neuron to spike if a certain threshold condition is met.

The relatively simple topology shown in FIG. 4A includes an input layer, one hidden layer, and an output layer. For example, the input layer can include p neurons, the hidden layer can include q neurons, and the output layer can include n neurons. In a particular example, an example SNN was generated using techniques described herein from an ANN having 128 input nodes, 128 nodes in a hidden layer, and 10 output nodes, in which each layer is fully connected to each preceding layer. Such an ANN is described as Dense MNIST in Appendix A, which is hereby incorporated herein by reference in its entirety. An SNN converted from such an ANN can include p=128 neurons in the input layer, q=128 neurons in the hidden layer, and n=10 neurons in the output layer.

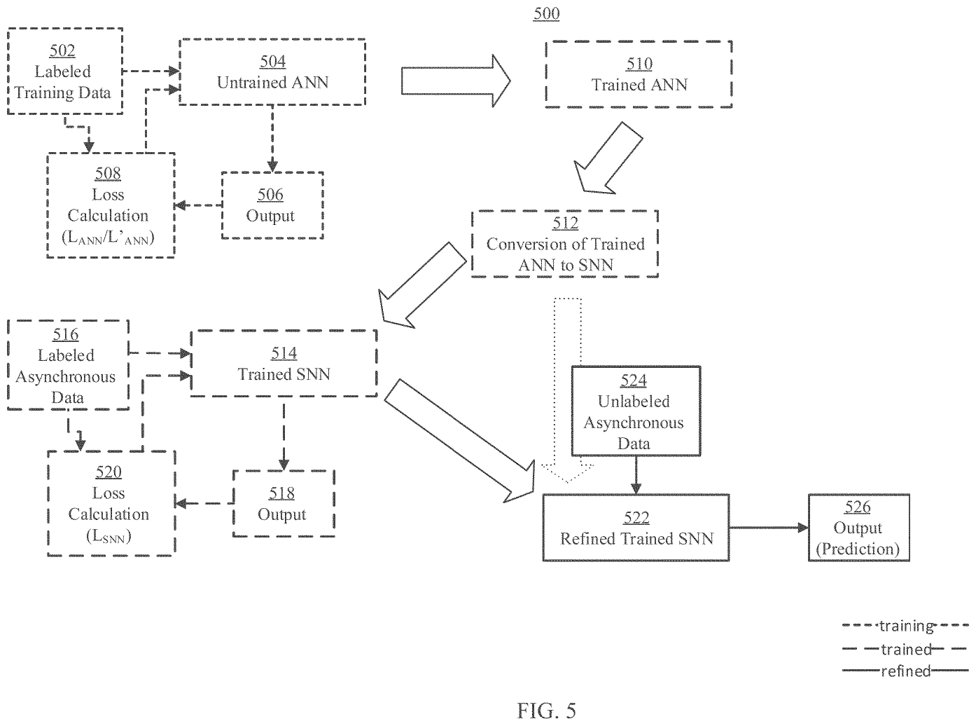

FIG. 4B shows an example of scaling of incoming weights and outgoing weights of a neuron in an SNN that can be used to enhance efficiency of an SNN using mechanisms described herein in accordance with some embodiments of the disclosed subject matter. As described in more detail below in connection with EQ. (6) and in connection with FIG. 5, each incoming connection to a neuron, which can be referred to as a synapse, can be associated with a weight W, which can impact how much a spike from a neuron in a previous layer impacts the neuron. As described below in connection with FIG. 5, an SNN can be refined by scaling the incoming weights of a neuron by a factor η, and the incoming connection from that neuron to downstream neurons can be scaled by a factor 1/η. Effectively scaling steady-state firing rates can facilitate high accuracy, low latency, and low power consumption. Mechanisms described herein can be used to implement a scaling technique, which can explicitly account for some loss and can scale at the level of each neuron.

FIG. 4C shows an example of hardware that can be used to implement an SNN, which can be trained and enhanced using techniques described herein. An SNN can be implemented using neuromorphic hardware, such as processors developed for SpiNNaker.

In some embodiments, there are various axes of components and parameters that can be selected in process of configuring an SNN. For example, many different network topologies can be used to implement an SNN (e.g., by varying the number of neurons at each layer, the number of layers, etc.). Given a particular network topology, some of the axes that can be adjusted include the neuron model used to implement the neurons, the spike coding scheme, and the training technique(s) used.

The neuron model can characterize how individual neurons respond to input, update an internal state (e.g., membrane potential), and produce an output. For example, some neuron models are intended to approximate the electrical dynamics of biological neurons. For simplicity, mechanisms described herein are described in connection with a more abstract model, which is sometimes referred to as a non-leaky integrate and fire (NL-IAF) neuron. This model has several computational advantages. For example, the NL-IAF neuron model allows SNN training via conversion from a trained ANN. As another example, the NL-IAF neuron model has a lower computational cost of simulation than models that are intended to more closely approximate biological neurons. In a more particular example, neuron updates for NL-IAF neurons can be calculated using only multiplication and addition, whereas some other neuron models use exponentiation, which is generally more resource intensive. Additionally, matrix multiplication can be used to efficiently compute many updates in parallel. As yet another example, the NL-IAF neuron model does not utilize hand-tuned parameters (e.g., a refractory period or response time).

The NL-IAF model can be represented using the relationship:

$${Θ}_{j , t} = \{ \begin{matrix}1 & if {V}_{j , t} \geq 1 \\ 0 & else\end{matrix} , \qquad ( 3 )$$

where j represents the neuron index, t represents the current time step, and V_{j,t} represents the neuron membrane potential. The neuron can fire when the potential exceeds a pre-specified threshold (e.g., 1 in EQ. (3), however this is merely an example). The variable Θ_{j,t} can indicate whether a spike is fired by the j neuron at time t.

After a spike, the membrane potential can be reset by subtraction. Accordingly, if I_{j,t} is used to represent the incoming current at time t, the membrane potential Vⱼ at time t can be represented using the relationship:

V_{j,t}=V_{j,t-1}−Θ_{j,t-1}+I_{j,t} (4)

The incoming current I_{j,t} can be represented using the relationship:

I_{j,t}=s_{j,t}·wⱼ+bⱼ, (5)

where s_{j,t} can represent a binary-valued vector (e.g., 1 for a spike, 0 otherwise) of incoming spikes at time t, including one entry for each incoming synapse, wⱼ can represent a vector of synaptic weights associated with incoming synapses, and bⱼ can represent the neuron bias of neuron j.

FIG. 5 shows an example 500 of a flow for training, enhancing, and using SNNs with improved efficiency in accordance with some embodiments of the disclosed subject matter. In some embodiments, mechanisms described herein can be used to train and refine an SNN to perform at least a portion of a computer vision task, such as classification of image data (e.g., classifying an image as including a particular class of object), segmentation of a portion of an image (e.g., identifying which portion(s) of an image represents an object that falls within a particular class, or that has particular characteristics). Note that although mechanisms described herein are general described in connection with image data, this is merely an example, and mechanisms described herein can be used to refine an SNN trained to perform a task associated with any suitable sequential data, such as image data, audio data, spatial data, seismography data, etc. Sequential data may or may not be time-series data.

Note that SNNs are often non-differentiable (see, e.g., EQ. (4)), so conventional backpropagation cannot be used for training an SNN. There are various classes of SNN training techniques that can be used in lieu of backpropogation of an SNN directly. For example, spike-based backpropagation techniques have been developed that use a differentiable proxy to approximate non-differentiable dynamics. As another example, local learning techniques have been developed that adjust synapse weights using only locally available information (e.g., pre and post-synaptic firing times). As yet another example, ANN conversion techniques have been developed that can generate synapse weights for an SNN with a similar topology to the ANN based on weights associated with corresponding nodes of the ANN. In some embodiments, mechanisms described herein can use ANN to SNN conversion techniques. In ANN to SNN conversion, an ANN can be trained using conventional backpropagation and the resulting weights can be copied to an SNN. In comparison to spike-based backpropagation and local learning, ANN conversion can achieve higher accuracy and can scale better to large-scale datasets (e.g., datasets like ImageNet). However, some mechanisms described herein can be used in connection with SNN training techniques other than ANN to SNN conversion. For example, rather than starting with an untrained ANN (e.g., as described below in connection with 502-512), process 500 can start with an untrained SNN (e.g., in lieu of a trained SNN at 514). In such an example, 502-512 can be omitted, and process 500 can start at 514 (with an untrained SNN rather than a trained SNN).

As shown in FIG. 5, labeled training data 502 can be used to train an untrained ANN 504. In some embodiments, labeled training data 502 can include any suitable data. For example, labeled training data 502 can include images that depict various classes of objects, with each image labeled based on the object(s) that is included in the image. Such training data can be used to train an ANN to perform an image classification task (e.g., to predict whether an object of a particular class is present in an unlabeled image). In a more particular example, labeled training data 502 can include images from the ImageNet database labeled based on the object class in the image. As another example, can include images that depict one or more classes of objects, with each pixel of the image labeled as corresponding to a particular category, such as a particular object, background, etc. Such training data can be used to train an ANN to perform an image segmentation task (e.g., to predict which pixels of an unlabeled image, if any, depict a particular type of object). Note that these are merely an examples, and labeled training data 502 can include any suitable data labeled using any suitable techniques.

In some embodiments, untrained ANN 504 can be trained (e.g., using computing device 110, using server 120, using computer vision system 104) using labeled training data 502. In some embodiments, untrained ANN 504 can have any suitable topology, such as a topology described in Appendix A, or any other suitable topology. For example, the ANN can be a relatively simple feed forward network (e.g., similar to the network shown in FIG. 4A). As another example, the ANN can be a complex convolutional neural network (CNN) or other deep learning network. As yet another example, the ANN can be any other suitable feed forward network. In a more particular example, the ANN can be a relatively simple stacked architecture (e.g., LeNet, AlexNet, VGG). As another more particular example, the ANN can be a residual architecture with skipped connections (e.g., ResNet). As yet another more particular example, the ANN can be based on an architecture with early outputs (e.g., Inception).

In some embodiments, untrained ANN 504 can be trained using any suitable optimizer, such as stochastic gradient descent, Adam (e.g., based on an optimizer described in Kingma et al., “Adam: A Method for Stochastic Optimization,” available at arxiv(dot)org, 2014), RMSprop or any other suitable optimizer. As shown in FIG. 5, a particular labeled training sample can be provided as input to untrained ANN 504, which can generate output 506 representing an inference or set of inferences for the image and/or each pixel of time image (e.g., based on the type of task that the ANN is being trained to perform).

In some embodiments, labeled training data 502 can be formatted in any suitable format. For example, labeled training data 502 can be formatted as a color image (e.g., an RGB image). As another example, labeled training data 502 can be formatted as a monochrome image, such as a grayscale image. As yet another example, labeled training data 502 can be formatted as depth values (e.g., representing LiDAR data, representing 3D image data). As still another example, labeled training data 502 can be formatted as an image in which each pixel is associated with one or more intensity values (e.g., a single grayscale value, RGB intensity values, etc.) and a depth value. In some embodiments, intensity values associated with different colors can be input to untrained ANN 504 using different channels. For example, untrained ANN 504 can have a first channel corresponding to red, a second channel corresponding to green, and a third channel corresponding to blue. As another example, untrained ANN 504 can have a first channel corresponding to an intensity value (e.g., a grayscale value, a red value, etc.), another channel corresponding to a depth value, and any other suitable channels (e.g., corresponding to green and blue values).

In some embodiments, output 506 can formatted in any suitable format. For example, output 506 can be formatted as a set of predicted classifications (e.g., a value associated with various classes that the ANN is being trained to classify). As another example, output 506 can be formatted as a mask indicating which pixels correspond to a particular type of object. In a more particular example, if the ANN is being trained to segment a particular object, output 506 can include a value for each pixel indicating whether the pixel depicts a particular object (e.g., where a 1 indicates that the object is present in the pixel and a 0 indicates that the object is not present). In such an example, if there are n possible object classes, the output layer can be configured with n channels, such that the output channel has dimensions of height*width*n (h*w*n), such that each pixel is associated with n output nodes, with one output node corresponding to each class, and the output of each node can indicate a probability of membership in that class. At each pixel, the predicted class can the node with the highest output probability.

In some embodiments, output 506 generated for a training image can be compared to the label associated with the training to evaluate the performance of untrained ANN 504. For example, a loss value can be calculated using loss function L_{ANN}. Any suitable loss function L_{ANN} can be used to train untrained ANN 504, which can vary based on the task which untrained ANN 504 is being trained to perform.

In some embodiments, the loss value can be used to adjust weights of untrained ANN 504. For example, a loss calculation 508 can be performed (e.g., by computing device 110, by server 120, by material decomposition system 104) to generate a loss value that can represent a performance of untrained ANN 504. The loss value generated by loss calculation 508 can be used to adjust weights of untrained ANN 504.

In some embodiments, after training has converged (and the untrained ANN 504 performs adequately on test data), untrained ANN 504 with final weights can be used to implement as a trained ANN 510.

Additionally, in some embodiments, after training has converged, untrained ANN 504 can be further trained (e.g., which can be referred to as fine-tuning or refining) using an adjusted loss function L′_{ANN} that is configured to encourage sparsity in the SNN. As described below in connection with EQ. (11), untrained ANN 504 can be refined using a penalized loss function L′_{ANN}, that can encourage sparsity (e.g., reducing the number of spike events). In some embodiments, a trained ANN can be fine tuned using penalized loss function L′_{ANN} to promote sparsity in an SNN generated from the trained ANN. For example, an ANN that has previously been trained to perform a computer vision task based on synchronous data can be fine-tuned for conversion to an SNN to perform the same computer vision task based on asynchronous data without retraining the ANN. Alternatively, in some embodiments, untrained ANN 504 can be trained (e.g., from scratch) using loss function L′_{ANN}, such that training and of untrained ANN 504 is combined with fine-tuning to encourage sparsity. Note that in some applications described herein, training untrained ANN using L_{ANN} and refining using L′_{ANN} produced superior results (e.g., better accuracy and/or sparsity). However, training untrained ANN 504 from scratch using L′_{ANN} can result in a more efficient SNN (e.g., with better sparsity) than an ANN trained using only L_{ANN} (and in some applications, may produce better results than training and refining).

In some embodiments, trained ANN 510 can be converted (e.g., using computing device 110, using server 120, using computer vision system 104) to a trained SNN 514 at 512 using any suitable technique or combination of techniques. The topology of the ANN can be configured to facilitate conversion from ANN to SNN. For example, a rectified linear unit (ReLU) activation function can be used to implement activations in the ANN with relatively few exceptions (e.g., a final layer can be implemented using a softmax activation function). Using ReLU for activations can ensure that a valid mapping of nodes of the ANN to NL-IAF neurons is possible. As another example, max pooling layers can be omitted (e.g., average pooling layers can be used in lieu of max pooling). Note that this is merely an example, and other neuron models can correspond to different activation functions. For example, a sigmoid activation function can be represented using a leaky integrate and fire neuron model. In such an example, an SNN implemented using leaky integrate and fire neurons can be converted from an ANN implemented using sigmoid activation functions (e.g., in lieu of ReLU activation functions).

In some embodiments, a computing device (e.g., using computing device 110, using server 120, using computer vision system 104) executing the conversion at 512 can use multiple techniques to convert an ANN (e.g., an appropriately implemented ANN that uses ReLU and omits max pooling layers) to an SNN (e.g., with NL-IAF neurons). For example, the computing device can substitute a neuron for each node in the ANN, and can generate a synapse between nodes of different layers based on connections between nodes in the ANN. In a more particular example, for two fully connected layers (e.g., i and i+1), the computing device can replace each node in layer I with a neuron, and can replace each node in layer i+1 with a neuron. The computing device can generate a synapse between each neuron in layer i and each neuron in layer i+1.

As another more particular example, for two layers (e.g., i and i+1) of a convolutional network (e.g., implemented using a 3×3 convolution filter operation between layers), the computing device can replace each node in layer i with a neuron, and can replace each node in layer i+1 with a node. If layer i+1 of the ANN has an output of 32×32×64, layer i+1 of the SNN can include 32×32×64 neurons, and the computing device can generate a synapse from each of 3×3×64 neurons (i.e., 576 neurons) in layer i to each neuron in layer i+1. In such an example, synapse weights can be taken from the convolution kernel, and can be scaled by the batch normalization μ parameter, and the bias associated with neuron can be taken from the convolution bias, and then scaled and offset using the batch normalization μ and σ parameters.

As another example, the computing device can adjust the model weights for various neurons based on the batch normalization transforms associated with the neuron. This can incorporate batch normalization transforms form the ANN into the weights for the neurons, as the SNN does not include batch normalization. As another example, the computing device can apply data-based normalization to the ANN to dive the maximum activation toward 1 (the maximum possible firing rate). In a more particular example, the computing device can pass training data through the ANN and, at each layer, can scale the weights and biases such that the maximum activation becomes 1. As yet another example, the computing device can discard any ReLU activations, and can copy ANN layers to the SNN.

In some embodiments, the computing device can configure a preliminary input layer (e.g., prior to a first layer of neurons, which are referred to in FIG. 4A as an input layer) to convert floating-point values (e.g., image pixel intensities) to spike trains (e.g., for refinement of the SNN with additional training data). Alternatively, in some embodiments, during refinement the computing device can convert floating-point values (e.g., image pixel intensities) to spike trains prior to providing input to the first layer of neurons (e.g., the input layer). In some embodiments, a rate coding technique can be used to convert floating-point values into spike trains. For example, the input layer or the computing device can generate a spike train with a firing rate (e.g., the number of spikes per time step) that equals the floating-point pixel intensity. In some embodiments, a preliminary input layer can be omitted (and/or removed) from an SNN that is to be used with a data source that natively produces spike trains rather than floating point values (e.g., an image sensor configured to output pulses when single photons are detected). In such embodiments, the input spike trains can be provided to inputs of the neurons in the input layer (e.g., rather than a preliminary input layer converting floating point values to spike trains). Note that mechanisms described herein can produce outputs more quickly than conventional ANNs (e.g., providing a fast, relatively accurate result) regardless of whether the data source is a synchronous or asynchronous data source. For example, as described above in connection with FIGS. 3A to 3C, using an SNN rather than a conventional ANN can produce relatively fast and accurate output much sooner than an output is produced by the conventional ANN. Using mechanisms described herein can further reduce latency and improve power consumption of the SNN.

In some embodiments, the computing device can configure a final output layer to generate values indicative of a prediction about the input data based on the states and spike trains of output neurons. For example, an SNN trained as a classifier can be configured with an output layer that identifies a “most activated” neuron, and predicts a classification based on the class associated with that neuron. In such an example, as output neurons update at each time step, the prediction can change over time (e.g., output neuron 1 can be most active initially, but output neuron 3 may become most active as time advances). Note that the smooth Pareto optimal accuracy-latency curve of FIGS. 3B and 3C can be attributed to the ability of the prediction to change over time as changes in the most activated neuron change. By contrast, the output of an ANN is generated at a specific time step, and does not change (e.g., as shown in FIG. 3A).

In some embodiments, labeled asynchronous data 516 can be used to refine trained SNN 514. In some embodiments, labeled asynchronous data 516 can include any suitable data, such as data described above in connection with labeled training data 502. Note that although labeled asynchronous data 516 is described herein as asynchronous data, this is merely for convenience, and labeled asynchronous data 516 can be formatted as floating point values, and a preliminary input layer of trained SNN 514 can convert the data to spike trains. In some embodiments, labeled asynchronous data 516 can be formatted in any suitable format, such as a format(s) described above in connection with labeled training data 502.

In some embodiments, trained SNN 514 can be refined (e.g., using computing device 110, using server 120, using computer vision system 104) using labeled asynchronous data 516 using any suitable technique or combination of techniques. For example, in some embodiments, trained SNN 514 can be refined using any suitable optimizer, such as a derivative-free optimizer (e.g., because the NL-IAF neuron model is not differentiable). For example, the SubPlex algorithm included in the NLopt Nonlinear Optimization Package. However, this is merely an example, and any suitable optimizer can be used during refinement of trained SNN 514, such as constrained optimization by linear approximations (COBYLA), principal axis (PRAXIS), Nelder-Mead simplex, or any other suitable derivative-free optimizer. As shown in FIG. 5, a particular labeled training sample from labeled asynchronous data 516 can be provided as input to trained SNN 514, which can generate output 518 representing an inference or set of inferences for the input and/or each pixel of time image (e.g., based on the type of task that the SNN is being trained to perform).

In some embodiments, output 518 can formatted in any suitable format. For example, output 518 can be formatted as a set of predicted classifications (e.g., a value associated with various classes that the ANN is being trained to classify). As another example, output 518 can be formatted as a mask indicating which pixels correspond to a particular type of object. In a more particular example, if the SNN is trained to segment a particular object(s), output 518 can include a value for each pixel indicating whether the pixel depicts a particular object. For example, if there are n possible object classes, the output layer can be configured with n channels, such that the output channel has dimensions of height*width*n (h*w*n), such that each pixel is associated with n output neurons, with one output neuron corresponding to each class. At each pixel, the predicted class can be based on the most activated neuron of the n neurons associated with the pixel.

In some embodiments, output 518 generated for a labeled input (e.g., input image) can be compared to the label associated with the labeled input to evaluate the performance of trained SNN 514. For example, a loss value can be calculated using a loss function L_{SNN} Any suitable loss function L_{SNN} can be used to refine trained SNN 514, such as a loss based on latency briskness (e.g., described above in connection with EQ. (1)) and/or a loss based on power briskness (e.g., described above in connection with EQ. (2)).

In some embodiments, the loss value can be used to adjust properties of trained SNN 514. For example, a loss calculation 520 can be performed (e.g., by computing device 110, by server 120, by material decomposition system 104) to generate a loss value that can represent a performance of trained SNN 514. The loss value generated by loss calculation 520 can be used to adjust properties of trained SNN 544.

A spike coding scheme can define the correspondence between a spike train and a real-valued activation. In general, a spike coding scheme is not explicitly implemented for an SNN, but instead arises implicitly from the neuron model. Examples of coding schemes include temporal coding and rate coding. A temporal spike coding scheme can encode activations based on the absolute firing times of the neurons. A rate spike coding scheme can encode activations based on mean firing rates of the neurons. Rate coding offers many advantages, including ease of interpretation, naturally pairing with the NL-IAF neuron model, and robustness to noise in spike arrival times. A disadvantage of rate coding in general is the large number of spikes that may be required to represent each activation. However, mechanisms described herein can reduce the number of spikes that represent each activation, mitigating this potential disadvantage of rate coding and thereby increasing the performance of computing devices that utilize rate coding to make predictions.

Characteristics of an SNN, such as accuracy, latency, and power consumption of the SNN are related to the firing rates of the neurons in the SNN. A spiking neuron j can be characterized as having an output spike train Θ_{j,1}, Θ_{j,2}, . . . , Θ_{j,T}. A steady-state firing rate r_{j,∞} can be represented using the relationship:

$${r}_{j , ∞} = {lim}_{T \to ∞} ( {1}_{T} {\sum }_{t = 0}^{T} {Θ}_{j , t} ) \qquad ( 6 )$$

Adjustments to the SNN that cause changes to steady-state firing rates can impact model properties. Mechanisms described herein can adjust properties of an SNN to change the steady-state firing rate of neurons of the SNN to values that achieve desirable model properties, such as high accuracy, low latency, and/or low power consumption (e.g., via an optimization process). In a more particular example, neurons with low firing rates (e.g., a relatively small value of r) may take many time steps to produce a first spike as an output, whereas neurons with firing rates greater than 1 (which can be referred to as a relatively large value of r) can saturate and code an incorrect value. Combining many neurons in a network results in more complex and subtle behaviors that emerge from interactions of the neurons.

In a rate coded SNN, scaling the activation of a neuron by a factor η≥0 can impact a steady-state firing rate of the neuron (e.g., scaling the neuron by factor η can change the value of r). Additionally, in some embodiments, mechanisms described herein can change the activation scale η without altering the network representation or substantially negatively impacting accuracy. For example, mechanisms described herein can scale weights of downstream neurons to reduce or eliminate an adverse impact that activation scale η may otherwise cause.

In some embodiments, mechanisms described herein can iteratively (e.g., using an optimization process) adjust activation scaling factors η associated with neurons of an SNN to improve performance and/or efficiency of the SNN (e.g., resulting in reduced latency and/or reduced power consumption).

A scaling set H can be defined that include scaling factors η for a network N (e.g., all scaling factors η for the network). For example, ηⱼ≥0 can be an activation scaling factor for the j^{th} neuron in network N, and scaling set H={ηⱼ} can include all scaling factors for the network N.

In some embodiments, mechanisms described herein can refine trained SNN 514 based on some loss L_{SNN} (e.g., based on latency briskness and/or power briskness) on the output (e.g., output 518) and dynamics of the SNN. In some embodiments, mechanisms described herein can use an initial scaling set H₀ for the trained SNN (e.g., trained SNN 514). During a refinement process for trained SNN 514, mechanisms described herein can considerably reduce L_{SNN} from the value of L_{SNN} generated using scaling set H₀ by explicitly refining L_{SNN} over H. For example, L_{SNN} can be evaluated by simulating the SNN (e.g., using computing device 110, using server 120, using computer vision system 104); which can accurately reflect spiking temporal dynamics. Many loss function L_{SNN} can be used to refine an SNN, and a particular example is described below.

Conventional techniques for scaling neurons generally only allow scaling at the level of the layer, based on the assumption that more granular scaling would cause the SNN to depart from the ANN representation. However, as described below, mechanisms described herein can be used to scale at more granular scale than the layer level without causing the SNN to depart from the ANN representation (e.g., without significantly impacting accuracy). For example, if layer i+1 is weighted, it is possible to scale layer i at the neuron level without altering the network representation.

In some embodiments, mechanisms described herein can scale the activation of neuron j by ηⱼ by multiplying the incoming weights (e.g., weights of incoming synapses) and bias by ηⱼ. Additionally, mechanisms described herein can isolate the change by multiplying the outgoing weights by 1/ηⱼ (e.g., as shown in FIG. 4B). The net result of such “isolated scaling” can be that only the activation of neuron j changes, so the ANN representation and output are substantially preserved.

In some embodiments, “neuron-level scaling” can be applied at the channel level in convolutions (e.g., due to consequences of weight sharing between neurons in the same channel). For example, a convolution layer

Additionally, in some embodiments, unweighted pooling layers generally lack adjustable weights, and accordingly cannot be scaled (e.g., if the layer i+1 is an unweighted pooling layer, such as a max pooling layer). In some embodiments, mechanisms described herein can use weighted pooling (e.g., average pooling) in the ANN and, before conversion, such weighted pooling can be replaced with an equivalent depthwise convolution.

In some embodiments, mechanisms described herein can use a loss function L_{SNN} that can be represented using the relationship:

L_{SNN}(H)=λ_{M}M(H)+λ_{L}b_{L}(H)+λ_{P}b_{P}(H), (7)

where M can be the minimum of the error 1−aₜ over all t, and λ_{M}, λ_{L}, and λ_{P} can be tradeoff hyperparameters that indicate the relative importance of accuracy, latency, and power consumption, respectively. In some embodiments, tradeoff hyperparameters can be set manually. As described above, when a neuron model is not differentiable, a derivative-free optimizer can be used to perform an optimization process based on L_{SNN}.

In some embodiments, mechanisms described herein can refine the SNN by varying scaling factors of the SNN at various levels of granularity. For example, mechanisms described herein can perform model-level scaling (e.g., using one global η), layer-level scaling (e.g., using one η per layer), and neuron-level scaling (e.g., using one η per neuron) in that order. Without a performant SNN simulator, the derivative-free optimizations can take an impractical amount of time to perform. Accordingly, in some embodiments, mechanisms described herein can use a simulator (e.g., the SaRNN simulator described above) which can simulates a wide range of SNN architectures with practical and relatively short computational times (e.g., orders of magnitude lower computational times than conventional SNN simulators). For example, SaRNN can achieves computational gains by implementing spiking layers as custom TensorFlow recurrent neural network (RNN) layers and compiling models to static, highly optimized TensorFlow graphs. SaRNN can support Message Passing Interface (MPI), facilitating parallel processing via division of data over multiple GPUs and/or compute nodes. Additionally, SaRNN supports ANN conversion, SNN saving and loading, firing rate scaling, and simulation with other backends via PyNN.

In some embodiments, an SNN response can be divided into multiple states, which can indicate where on the accuracy curve the output of the SNN falls. For example, an SNN can have a network initial state, a network steady state, and a network transient state. In some embodiments, an initial state I of an SNN N can be characterized by a set of initial neuron potentials V₀, and can be expressed as I={V₀_{ⱼ}}. An SNN N can be in a steady state at time T is, for all neurons j∈N and all times τ≥T, the following relationship is satisfied for some ϵ>0:

$$\vert {r}_{j , ∞} - \frac{1}{τ} {\sum }_{t = 0}^{τ} {Θ}_{j , t} \vert < ϵ . \qquad ( 8 )$$

In some embodiments, an SNN N is in a transient state if it is not yet in a steady state, and is no longer in the initial state.

In an SNN, a direct relationship exists between the duration of the transient state and the latency of the network (e.g., as shown conceptually in FIGS. 3B and 3C). The temporal evolution of a spiking neural network generally depends on multiple factors, the sequence of inputs, the network parameters, and the initial state. In general, the sequence of inputs cannot be controlled, as the sequence of inputs to a deployed SNN can be expected to be novel. However, two of these factors can be adjusted. For example, adjusting the scaling of each neuron (e.g., using scaling factor η) and changing the sparseness of the network can both alter the network parameters. As another example, the initial state of the SNN can be adjusted, and the initial state V₀ can strongly influence the duration of the transient state.

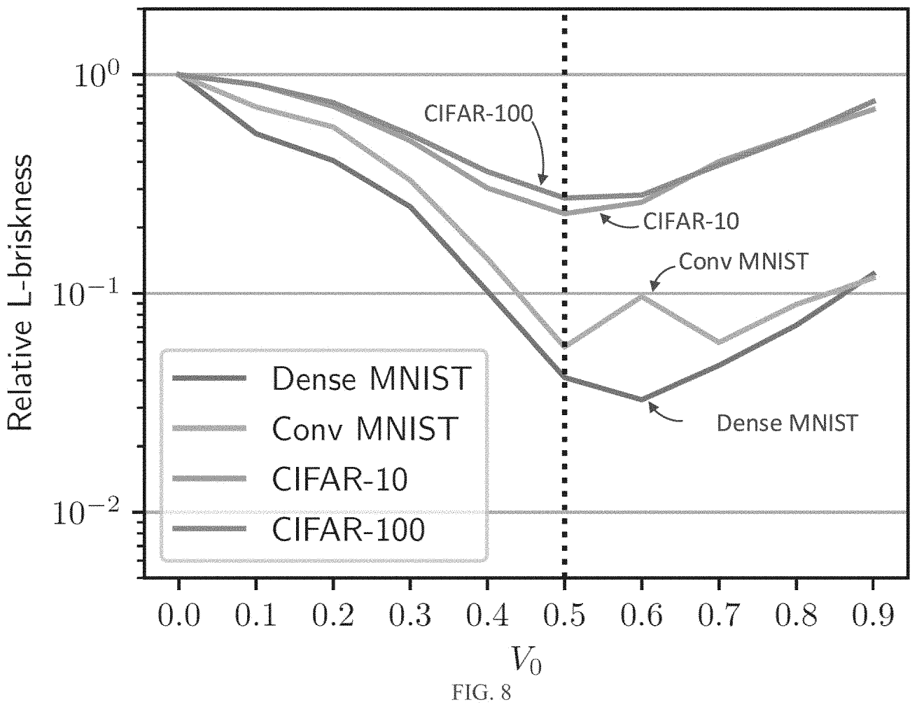

In general, neurons can be initialized to a single common global value, or different neurons can be initialized with different values. For example, in some embodiments, mechanisms described herein can initialize all neurons with a global V₀. In many conventional SNNs, neurons are all initialized to a global value V₀=0, which can be referred to as a “cold start” initial model state. A cold start can result in relatively high latency (e.g., depicted in FIG. 3B). As described below, if a global values is used, a value V₀=0.5, which can be referred to as a “warm start” initial model state, can represents a more natural state and can improve performance (e.g., as shown in FIG. 8).

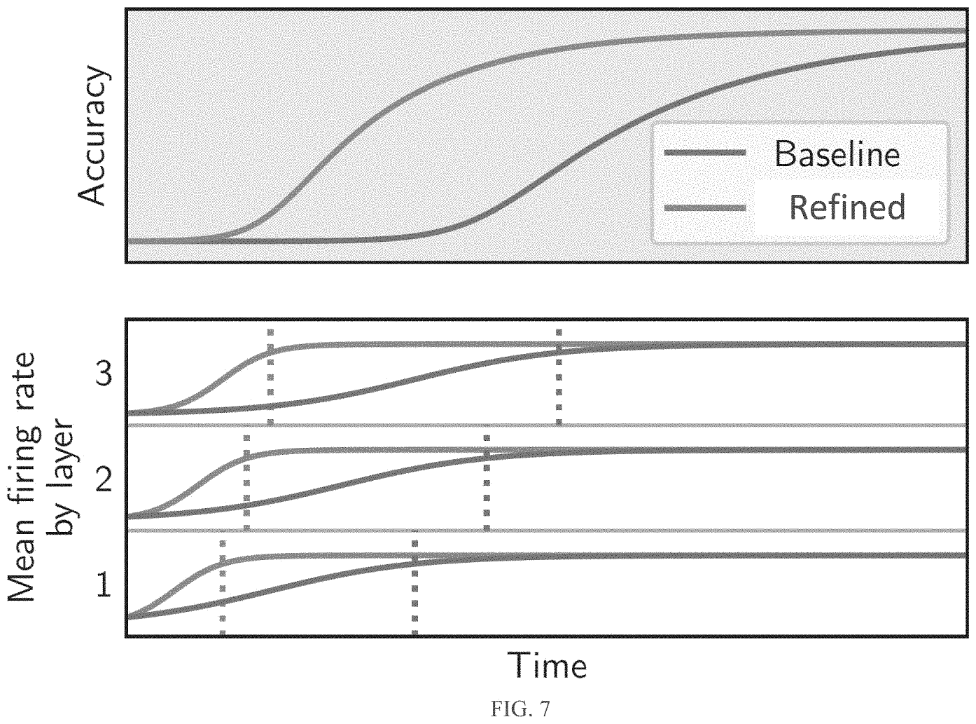

In some embodiments, mechanisms described herein can refine the SNN over the SNNs initial state by allowing I to vary between neurons. For example, initial state I can be incorporated into the loss function described above in connection with EQ. (7) to create L_{SNN}(H, I). At each phase, the dimensionality of the search space can be increased (e.g., doubled) to include one value of V₀_{ⱼ} for each value of ηⱼ. Explicitly refining the SNN based on the initial state I (e.g., potentials V₀) can steepen the convergence curve, and reduce latency (e.g., as described below in connection with FIG. 7). Note that because layer i must converge to its steady-state for layer i+1 to receive an accurate input, the steepening effect can stack as the network gets deeper (e.g., the improvement in latency can be greater for deeper networks compared to use of a global V₀). Note that although refinement based on I is described as being performed concurrently with refinement based on H, this is merely an example, and mechanisms described herein can refine an SNN based on I without refining based on H (e.g., using a loss function L_{SNN}(I), rather than L_{SNN}(H, I)).

Note that refinement based on H and I target SNN dynamics, leaving the underlying ANN representation substantially unchanged. However, the ANN representation itself may cause inefficiency in the SNN. For example, although there have been approaches for sparsifying ANN representations (e.g., adjusting properties of the ANN to reduce the number of calculations needed to produce an output), ANN sparsity often does not directly translate into concrete efficiency gains for an SNN generated based on an ANN conversion. The unit of computation in an ANN is a matrix product, and sparse matrix multiplication algorithms often require high levels of sparsity to be effective. However, in an SNN, the unit of computation is a spike rather than a matrix product. Accordingly, sparsifying the neuron activations of an SNN can reduce the number of spikes, and sparsifying the weights can reduce the synaptic events generated per spike. In some embodiments, mechanisms described herein can adjust training of the ANN (e.g., at 502-508) by incorporating an activation loss term Lₐ and/or a synaptic sparsity loss term Lₛ, each of which is described below.

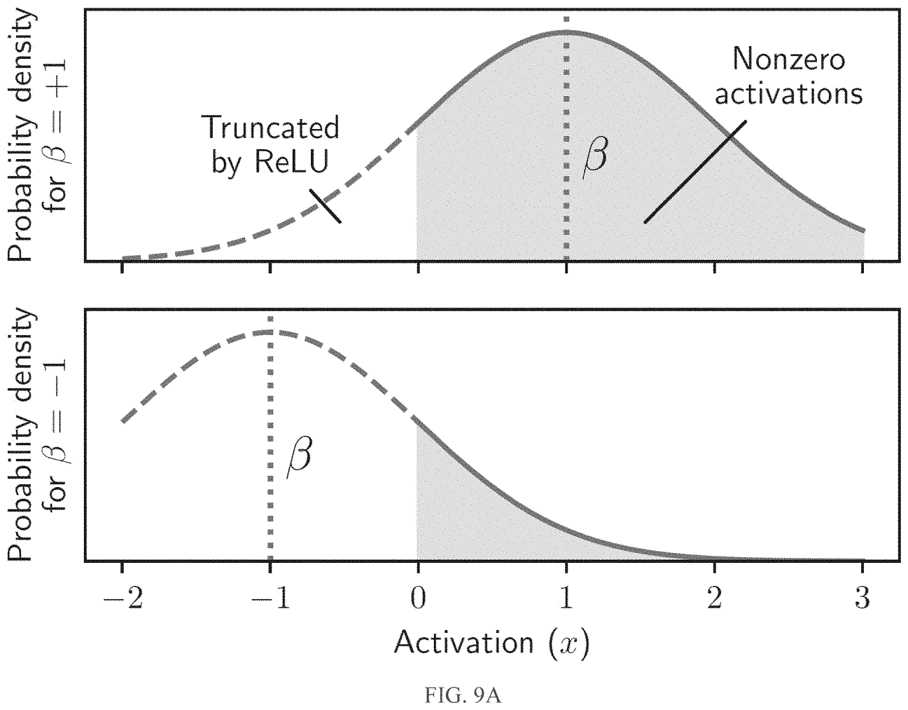

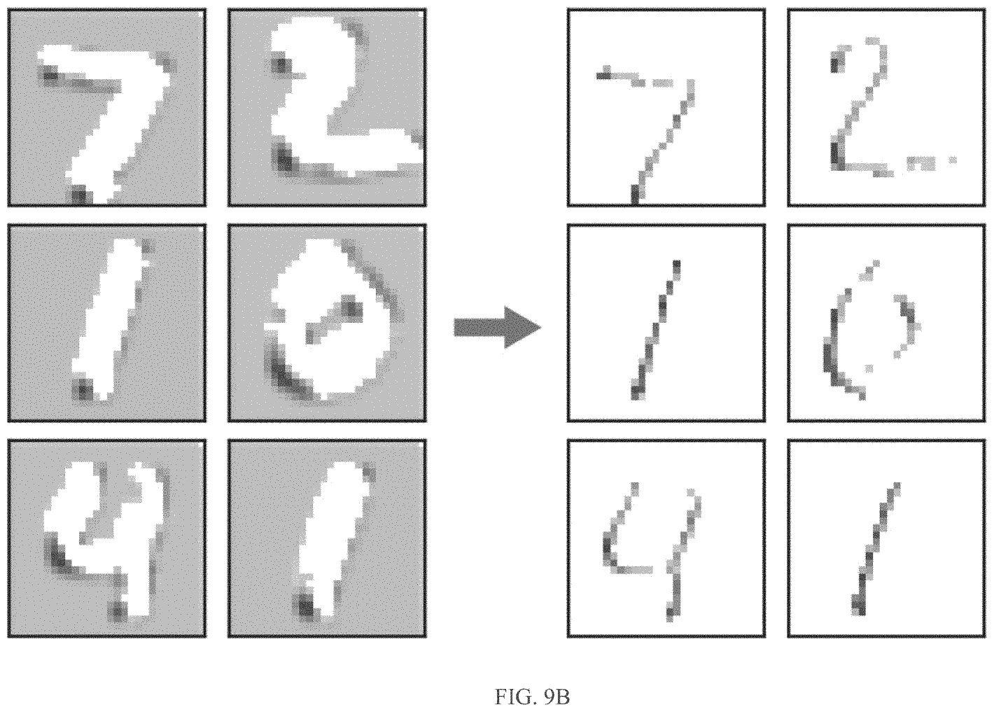

In some embodiments, activation loss term Lₐ can leverage batch normalization (BN) in the ANN. For example, as illustrated in FIG. 9A, the BN β parameter can control the mean of the activation distribution, and can be used to change the number of positive (e.g., nonzero after ReLU) activations.

In some embodiments, mechanisms described herein can use an activation loss term Lₐ represented by the relationship:

$${L}_{a} = \frac{1}{{\sum }_{k} {n}_{k}} {\sum }_{k} \frac{{n}_{k}}{2} ( erf ( \frac{{β}_{k}}{\sqrt{2}} ) + 1 ) , \qquad ( 9 )$$

where nₖ represents the number of neurons in the SNN corresponding to the k^{th} BN β value βₖ. In the BN after convolution, nₖ can correspond to the number of pixels per channel, and after a fully-connected layer nₖ can be 1.

In some embodiments, mechanisms described herein can use a synaptic sparsity loss term Lₛ represented by the relationship:

$${L}_{s} = \frac{1}{{\sum }_{k} {m}_{k}} {\sum }_{k} {m}_{k} \vert {w}_{k} \vert , \qquad ( 10 )$$

where mₖ represents the number of synapses corresponding to the k^{th} penalized weight wₖ. In a convolution, mₖ can correspond to the number of pixels per channel, and in a fully-connected layer mₖ can be 1. The Lₛ term can use an L1 (lasso) penalty to push weights very near zero, and after fine tuning of the ANN (e.g., using loss function L′_{ANN}), weights with magnitude less than some value ϵ can be removed. In some embodiments, ϵ can be set to any suitable value, where a higher value produces an SNN that is more sparse. However, as the value increases, the accuracy of the SNN may decrease. For example, ϵ can be set to a value that is much smaller than 0.01. In a more particular example, results described below in connection with FIGS. 8, 9B, 10, and 11 were generated using a value of ϵ=10⁻⁴.

In some embodiments, mechanisms described herein can use a penalized loss function L′_{ANN} that incorporates Lₐ and/or Lₛ. In some embodiments, the penalized loss L′_{ANN} can be represented using the relationship:

L′_{ANN}=L_{ANN}+λₐLₐ+λₛLₛ, (11)

where L_{ANN} can represent the loss used during initial training of an ANN, and λₐ and λₛ can be tradeoff hyperparameters that indicate the relative importance of activation sparsity and synaptic sparsity, respectively. In some embodiments, tradeoff hyperparameters can be set manually. Note that this is merely an example, and the ANN can be fine-tuned using one of Lₐ and Lₛ while omitting the other (e.g., using L′_{ANN}=L_{ANN}+λₐLₐ or L′_{ANN}=L_{ANN}+λₛLₛ). In some embodiments, minimizing L′_{ANN} can encourages an SNN representation with fewer nonzero activations, which can reduce the total number of spikes. Additionally or alternatively, in some embodiments, minimizing L′_{ANN} can encourages an SNN representation with fewer weights, which can reduce the number of synaptic events per spike. However, adjusting the activations and weights can maintaining approximately the same underlying network representation of the ANN and SNN. Accordingly, by reducing the number of spikes and/or synaptic events per spike, refining the ANN to sparsify the SNN can significantly reduce the power consumption of the SNN (e.g., which can be quantified using the P-briskness metric bₚ described above in connection with EQ. (2)) while maintaining similar overall accuracy. In some embodiments, ANN 504 can refined (e.g., using L′_{ANN}) using any suitable optimizer, such as stochastic gradient descent, Adam, RMSprop or any other suitable optimizer. However, using stochastic gradient descent may produce superior results when used with the L1 penalty, as adaptive optimizers (e.g., Adam or RMSprop) can incorrectly weight the penalty term.

In some embodiments, after refinement has converged, trained SNN 514 with final weights and initialization values can be used to implement a refined trained SNN 522, which can be used in a computer vision task (e.g., by computer vision system 104). In some embodiments, refinement of trained SNN 514 can be omitted (e.g., represented in FIG. 5 by the dotted block arrow between 512 and 522), and trained SNN 514 can be used in lieu of refined trained SNN 522. For example, trained SNN 514 can exhibit improved power efficiency via refinement of the ANN using loss function L′_{ANN}, and refinement using loss function L_{SNN} can be omitted. However, in general, refinement using loss function L_{SNN} can be expected to further improve efficiency of the SNN (e.g., latency and power efficiency).

As shown in FIG. 5, unlabeled asynchronous data 524 can be provided as input to refined trained SNN 522, which can generate one or more outputs 526 representing an inference or set of inferences for the input data and/or each pixel of input (e.g., based on the type of task that the SNN is being trained to perform).

FIG. 6 shows an example 600 of a process for training, enhancing, and using SNNs with improved efficiency to classify image data in accordance with some embodiments of the disclosed subject matter. As shown in FIG. 6, at 602, process 600 can train an ANN to perform a machine vision task or a task related to machine vision. In some embodiments, process 600 can use any suitable technique or combination of techniques to train the ANN, such as techniques described above in connection with 502-510 of FIG. 5.

Alternatively, in some embodiments, process 600 can receive, at 602, a representation of an ANN that has been pre-trained to perform a machine vision task or a task related to machine vision. 502-510 of FIG. 5.

At 604, process 600 can adjust parameters of the trained ANN to sparsify the SNN to be generated by conversion of the ANN, reducing latency and/or power consumption of the SNN. In some embodiments, process 600 can adjust the ANN using any suitable technique or combination of techniques that lead to the SNN being sparsified (e.g., reducing the number of activations and/or synaptic events by the SNN compared to the number of activations and/or synaptic events produced before adjustment of the ANN. For example, in some embodiments, process 600 can use techniques described above in connection with EQS. (9) to (11). In a more particular example, process 600 can use a loss function L′_{ANN} to fine tune an ANN that was trained using a loss function L_{ANN}. In such an example, loss function L′_{ANN} can include an activation loss term Lₐ and/or a synaptic sparsity loss term Lₛ. In some embodiments, process 600 can omit 604. For example, an SNN can be refined without sparsifying the SNN (e.g., using a loss function L_{SNN}(H, I), L_{SNN}(H), or L_{SNN}(I)), which can improve efficiency of the SNN regardless of whether the SNN has been sparsified.

At 606, process 600 can convert the trained and ANN to an SNN using any suitable technique or combination of techniques. For example process 600 can use techniques described above in connection with 512 of FIG. 5. In some embodiments, process 600 can omit 602-606. For example, process 600 can receive a trained SNN which may or may not have been converted from an ANN, and may or may not have been sparsified using techniques described herein. Alternatively, in some embodiments, process 600 can train an SNN using any suitable SNN training techniques.

At 608, process 600 can adjust neuron weights of the SNN to improve accuracy, to reduce latency, and/or to reduce power consumption. In some embodiments, process 600 can use any suitable technique or combination of techniques to adjust neuron weights of the SNN. For example, as described above in connection with 514-520, process 600 can use a loss function L_{SNN} that is calculated based on performance of the SNN after adjusting neuron weights (e.g., as described above in connection with EQ. (7)).

In some embodiments, process 600 can adjust one or more values in a set of neuron scaling weights H (e.g., as described above in connection with 514 of FIG. 5), and can use L_{SNN} to determine whether the changes to the set of neuron scaling weights H improved performance of the SNN. As described above in connection with EQ. 7, L_{SNN} can include an accuracy term (e.g., including M(H)), a latency term (e.g., including b_{L} (H)), and/or a power consumption term (e.g., including b_{P}(H)).

In some embodiments, process 600 can select a global neuron scaling weight (e.g., η_{global}) using L_{SNN} to identify a value for η_{global} that minimizes L_{SNN} when applied to H₀. Additionally or alternatively, in some embodiments, process 600 can find a set of layer-level neuron scaling weights (e.g., ηᵢ) that minimize L_{SNN}. For example, if the SNN includes five layer, process 600 can adjust each of five layer-level neuron scaling weights ηᵢ for 1≤i≤5.

In some embodiments, process 600 can find a set of neuron-level neuron scaling weights (e.g., ηⱼ) that minimize L_{SNN}. As described above in connection with FIG. 4B, process 600 can weight each neuron by a scaling weight ηⱼ, by multiplying a bias of each neuron by ηⱼ, and multiplying a weight applied to each outgoing synapse by 1/ηⱼ at the neuron on the other end of the synapse.

For example, if neurons j in layer i and j+1 in layer i+1 of an SNN network N, process 600 can find a global scaling weight η_{global} that minimizes L_{SNN} by iteratively adjusting and applying values of η_{global} such that the weights associated with neuron j after fine-tuning the global scaling weight can be expressed as η_{global}*wⱼ and η_{global}*bⱼ, when i is the input layer, and the weights associated with neuron j+1 after fine-tuning the global scaling weight can be expressed as wⱼ₊₁ and bⱼ₊₁. As described below in connection with neuron-level scaling (and above in connection with FIG. 4B), each neuron input can be weighted by global scaling weight η_{global} and each outgoing weight from the neuron can be weighted by 1/η_{global}. Accordingly, the end result of global scaling can be that only the input layer is scaled by η_{global} after global fine-tuning, while the other layers are unaffected by global scaling. In such an example, process 600 can find layer-level scaling weights ηᵢ that minimize L_{SNN} by iteratively adjusting and applying values of ηᵢ to each layer. The weights associated with neuron j after fine-tuning the layer-level scaling weights can be expressed as

$$\frac{1}{{η}_{i - 1}} {η}_{i} * {η}_{global} * {w}_{j} and \frac{1}{{η}_{i - 1}} {η}_{i} * {η}_{global} * {b}_{j}$$

(note that as described above, η_{global} can be omitted for layers other than the input layer, and for the input layer,

$$\frac{1}{{η}_{i * 1}}$$

can be omitted as there is no previous layer to which weight ηᵢ₋₁ was applied), while the weights associated with neuron j+1 after fine-tuning the layer-level scaling weights can be expressed as

$$\frac{1}{{η}_{i}} {η}_{i + 1} * {η}_{global} * {w}_{j + 1} \frac{1}{{η}_{i}} {η}_{i + 1} * {η}_{global} * {b}_{j + 1} .$$

Continuing the example, process 600 can find neuron-level scaling weights that minimize L_{SNN} by iteratively adjusting and applying values of ηⱼ to each neuron. The weights associated with neuron j after fine-tuning the neuron-level scaling weights can be expressed as

$$\frac{1}{{η}_{i , incoming}} {η}_{j} * \frac{1}{{η}_{i - 1}} {η}_{i} * {η}_{global} * {w}_{j} and$$

$$\frac{1}{{η}_{i , incoming}} {η}_{j} * \frac{1}{{η}_{i - 1}} {η}_{i} * {η}_{global} * {b}_{j}$$

bⱼ, where η_{j,incoming} is a product of the neuron level scaling weights applied to each neuron in level i−1 to which neuron j is connected. Similarly, weights associated with neuron j+1 after fine-tuning the neuron-level scaling weights can be expressed as

$$\frac{1}{{η}_{j + 1 , incoming}} {η}_{j + 1} * \frac{1}{{η}_{i}} {η}_{i} * {η}_{global} * {w}_{j + 1} and$$

$$\frac{1}{{η}_{j + 1 , incoming}} {η}_{j + 1} * \frac{1}{{η}_{i - 1}} {η}_{i} * {η}_{global} * {b}_{j + 1} ,$$

bⱼ, where ηⱼ₊₁,incoming is a product of the neuron level scaling weights applied to each neuron in level i to which neuron j is connected, including ηⱼ. Note that neurons in the final layer can remain unscaled (e.g., during neuron level scaling), due to the absence of outgoing weights to scale (e.g., there are no incoming weights for neurons in a next layer, because there is not a next layer).

At 610, process 600 can find a set of neuron initialization values (e.g., V₀) that minimize L_{SNN}. As described above in connection with 514 of FIG. 5, process 600 can select an initialization value for each neuron starting from initial values. For example, process 600 can start from an initial global value, such as V₀=0 or V₀=0.5, or initial values that vary between neurons (e.g., randomly, using predetermined values, etc.).

In some embodiments, process 600 can adjust one or more values in initial state I (e.g., as described above in connection with 514 of FIG. 5), and can use L_{SNN} to determine whether the changes to the set of initialization values improved performance of the SNN. As described above in connection with EQ. 7, L_{SNN} can include an accuracy term (e.g., including M(I)), a latency term (e.g., including b_{L} (I)), and/or a power consumption term (e.g., including b_{P}(I)).

In some embodiments, process 600 can use an initial global neuron initialization value (e.g., V₀_{_{global}}) using L_{SNN} to identify a value for V₀_{_{global}} that minimizes L_{SNN}. Additionally or alternatively, in some embodiments, process 600 can find a set of layer-level and/or neuron level initialization values (e.g., V₀_{ⱼ}) that minimize L_{SNN}.

In some embodiments, after fine-tuning of initialization values, a mean initialization values can be about 0.5 (e.g., within about 10% of 0.5), and the standard deviation of the initialization values of each neuron can be greater than 10% of the mean. For example, the standard deviation can be at least about 10% of the mean initialization value (e.g., at least 0.05 for a mean initialization value of about 0.5). As another example, the standard deviation can be at least about 15% of the mean initialization value (e.g., at least 0.075 for a mean initialization value of about 0.5). As yet another example, the standard deviation can be at least about 20% of the mean initialization value (e.g., at least 0.1 for a mean initialization value of about 0.5). As still another example, the standard deviation can be at least about 25% of the mean initialization value (e.g., at least 0.125 for a mean initialization value of about 0.5).

In some embodiments, 608 and 610 can be performed simultaneously. For example, process 600 can use a loss function that refines the SNN based on both neuron scaling weights H and neuron initialization values V₀ (e.g., as described above in connection with EQ. (7)). Alternatively, in some embodiments, process 600 can omit 608 and/or 610. For example, process 600 can fine tune the SNN using neuron scaling weights H alone, initialization state I alone, using neuron scaling weights H and initialization state I serially (e.g., as shown in FIG. 6), using neuron scaling weights H and initialization state I concurrently (e.g., using a single loss function L_{SNN}), or using neither neuron scaling weights H and initialization state I (e.g., process 600 can sparsify the SNN at 604, and can omit 608 and 610).

At 612, process 600 can provide any suitable data as input to the SNN. For example, process 600 can provide image data formatted similarly to the image data used to train the ANN from which the SNN was converted (and/or used to train and/or refine the SNN). In a more particular example, process 600 can provide image data formatted in any suitable format described above in connection with 502 of FIG. 5. Note that although process 600 is described in connection with image data, this is merely an example, and process 600 can be used with any suitable sequential data.

At 614, process 600 can begin receiving output (e.g., for time step t) from the SNN. For example, if process 600 is configured to perform a computer vision task that uses a classification of image data, process 600 can receive an output indicative of a classification of the input image data.

At 616, process 600 can perform a computer vision task based on a current output of the SNN. For example, process 600 can make an inference about a physical environment captured in the image data, such as the presence or absence of particular types of obstacles, which can be used to plan a route for autonomous navigation. In some embodiments, process 600 can determine a current time step associated with the input data, and can infer a confidence in the output based on the current time step (e.g., based on where the time step falls on a latency-accuracy trade-off curve). Note that this is merely an example, and process 600 can perform any suitable computer vision task(s), and/or tasks related to other applications associated with other types of data.

Process 600 can return to 612 to receive additional data (e.g., for time step t+1), or alternatively can return to 612 to receive new data (e.g., starting at t=0).

FIG. 7 shows an example of efficiency improvements that can be realized using mechanisms described herein for enhancing SNN efficiency in accordance with some embodiments of the disclosed subject matter. As described above in connection with FIGS. 3B and 3C, before converging to a steady state, an SNN spends time in a transient state. As described above, choices of an initial state I has a strong effect on the duration of the transient state. As shown in FIG. 7, a poor choice of initial state I (represented as baseline in FIG. 7) can cause layers to converge relatively slowly to their steady-state firing rates. This can have a cascading effect in later layers, resulting in a long transient state and high latency. Refining the SNN using techniques described herein can reduce latency by reducing the transient time associated with each layer (e.g., based on neuron initialization values).

FIG. 8 shows another example of efficiency improvements that can be realized using mechanisms described herein for enhancing SNN efficiency in accordance with some embodiments of the disclosed subject matter. The results described in connection with FIGS. 8, 9B, 10, and 11 were generated using simulations of SNNs trained and refined using techniques described herein. For example, four ANNs were trained: dense MNIST, convolutional MNIST, and convolutional CIFAR-10/100. Additional description of the model architectures and experiment parameters are described in Appendix A. After initial training sparsity fine-tuning was performed (e.g., as described above in connection with 604). The ANNs were then converted to SNNs, and a derivative-free optimization over L_{SNN}(H, I) was performed. Optimization was performed in three phases (global, layer, and neuron) for 100, 1000, and 10000 iterations, respectively (i.e., the optimization was performed for both H and I simultaneously at each of the global, layer, and neuron levels, with one element of I for each element of H).

The results described in connection with FIGS. 8, 9B, 10, and 11 are based on a comparison of the final models to versions of the models generated without using techniques described herein (e.g., omitting 604, 608, and 610 from process 600; using loss function L_{ANN} at 508 of FIG. 5, omitting 514-520, and using V₀=0).

As shown in FIG. 8, there is a clear relationship between the global V₀ and latency. For most models, V₀=0.5 (e.g., a “warm start”) gives the lowest latency.

FIG. 9A shows an example illustrating an effect of bath normalization on ANN activation sparsity that can be used in connection with mechanisms described herein for enhancing SNN efficiency in accordance with some embodiments of the disclosed subject matter, and FIG. 9B shows an example illustrating activation maps for the two batch normalization values of FIG. 9A. As described above, sparsity in SNN weights and activations can improve efficiency. As shown in FIG. 9A, batch normalization can be used to control ANN activation sparsity. Shifting the batch normalization to the left can reduce the number of nonzero activations (illustrated with shading in FIG. 9A). As shown in the left panel of FIG. 9B, the ANN with β=1 activates on many regions of the input that are not relevant (note that activation is shown by shading, and non-activation is shown in white). In the right panel of FIG. 9B, an ANN refined to sparsify activations (e.g., by shifting β to left) learned not to activate in uninteresting parts of the image, dramatically reducing the number of activations for a particular input.

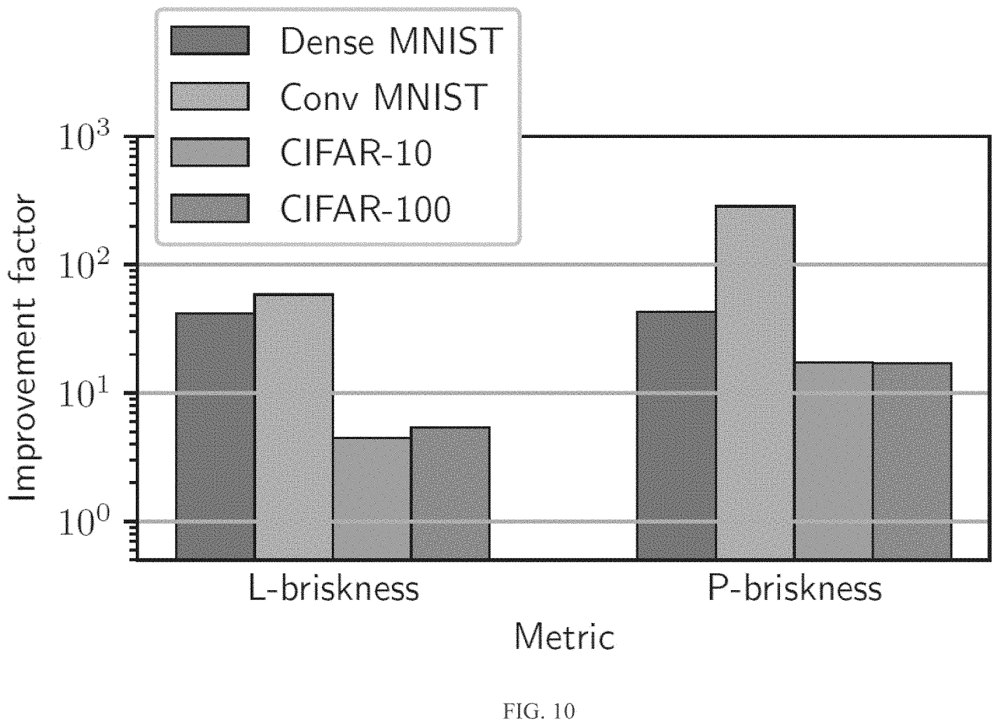

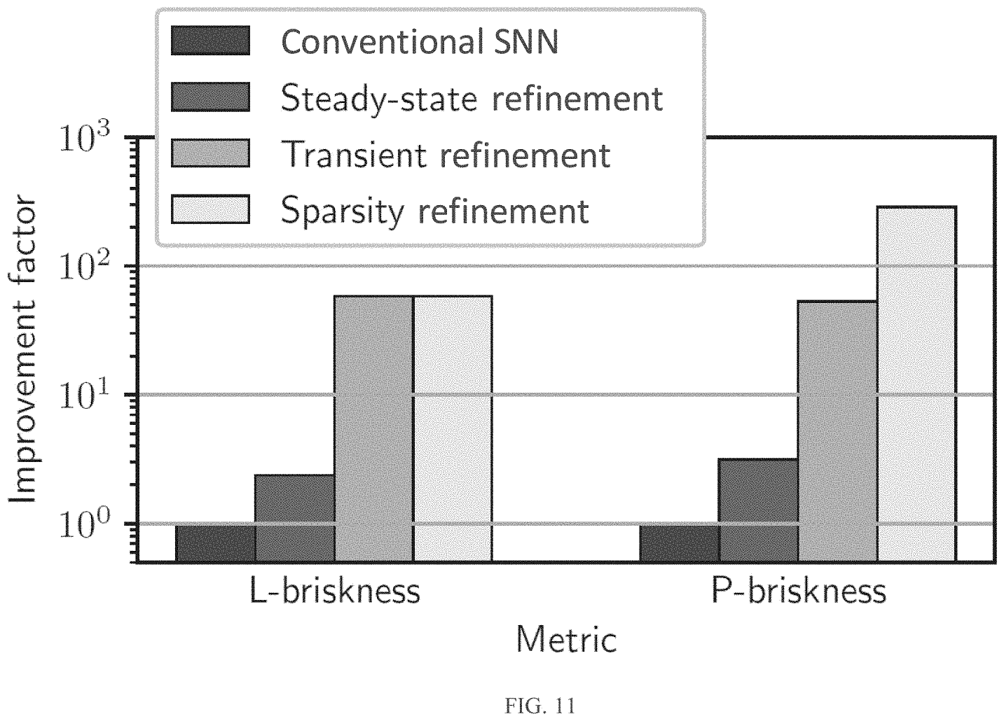

FIG. 10 shows examples of efficiency improvements realized using mechanisms described herein to enhance SNNs derived from various ANN model architectures. In FIG. 10 improvements in L-briskness and P-briskness are shown (e.g., an improvement of 10¹ in L-briskness can correspond to a reduction in L-briskness by an order of magnitude, whereas an improvement factor of 10⁰ indicates no improvement). Although the SNNs were explicitly optimized for b_{L} and b_{P}, improvements in threshold-based metrics (e.g., time or synaptic events before an accuracy threshold is crossed) were also observed, which are described further in Appendix A.

FIG. 11 shows example of efficiency improvements in multiple measures of efficiency realized using various mechanisms described herein to enhance SNNs derived from a convolutional MNIST model. As shown in FIG. 11, applying different techniques described herein can each improve one or more performance metrics. For example, using techniques described above in connection with 608 (referred to in FIG. 11 as steady-state refinement) for refining neuron weights improves both latency (e.g., measured using L-briskness as described above in connection with EQ. (1)) and power consumption (e.g., measured using P-briskness as described above in connection with EQ. (2)). As another example, using techniques described above in connection with 610 (referred to in FIG. 11 as transient refinement) for refining initialization state further improves latency and power consumption. As yet another example, using techniques described above in connection with 604 (referred to in FIG. 11 as sparsity refinement) for sparsifying the SNN activations and synaptic events can further improves power consumption, but did not have a substantial impact on latency. Note that the bar for transient refinement shows improvement when applying both steady-state refinement techniques and transient refinement techniques, and the bar for sparsity refinement shows improvement when applying steady-state refinement techniques, transient refinement techniques, and sparsity refinement techniques.

In addition to simulations described above in connection with FIGS. 8 to 11, mechanisms described herein were also applied to a simulated ImageNet model, which shows scalability of techniques described herein. The MobileNet architecture was used based on its high efficiency and compatibility with conversion constraints described above in connection with 512 of FIG. 5. To reduce the time for training and optimization, all images were downsized to 160×160. Because the goal of the simulation is not to achieve state-of-the-art ANN accuracy, the simulation was configured to provide relatively simple, reproducible training over maximum accuracy. The ANN achieved 49.09% validation accuracy for correctly classifying an unlabeled input image (e.g., the most active output neuron at the steady state of the SNN corresponds to the correct classification), and 74.92% validation accuracy for including the correct classification in the top 5 classifications of an unlabeled input image (e.g., the output neuron corresponding to the correct classification was in the top 5 most active output neurons of the SNN).

Note that simulations of SNNs took considerably longer times for an ImageNet model than for the simpler MNIST and CIFAR models. To reduce optimization times, the neuron-level phase was eliminated and the length of the layer-level phase was reduced by half (from 1000 to 500 iterations). Additionally, instead of simulating the entire training dataset at each iteration of refinement, a small fraction (e.g., 1000 items rather than approximately 1.28 million items in the full training set) of the dataset was simulated. Although reducing dataset size can cause overfitting for neuron-level optimization, overfitting did not seem to occur for global or layer-level optimization, even with relatively small datasets. With the above changes, the SNN optimization process took less time (e.g., four days total to optimize the SNN) than the training process for the original ANN (which was longer than four days).

Results of the simulations are shown in TABLE 1, which are for a duration of 1000 time steps. The “before” model is an SNN converted from the ANN prior to applying sparsity refinement techniques, and without application of steady-state or transient refinement techniques. Note the substantial accuracy difference between the “before” and “after” models. Because accuracy curves tend to flatten with time, the “before” model can take thousands of extra steps to reach the same accuracy (e.g., after 1000 steps, the “before” model had still not reached the steady-state accuracy of the ANN). After just 1000 steps, the “after” model is relatively close to the ANN accuracy of 49.09%.

TABLE 1

| Metric | Before | After |
|---|---|---|
| max{aₜ} | 30.06% | 46.29% |
| b_{L} | 762 | 342 |
| b_{P} | 4.99e9 | 1.14e9 |

In addition to reductions in b_{L} and b_{P}, note the dramatic improvement in peak accuracy after 1000 steps.

Additionally, techniques described herein were applied to a simulated version of SpiNNaker, a neuromorphic system that is part of the Human Brain Project, which can demonstrate improvements that can be realized by applying mechanisms described herein on a full-stack SNN-based perception system.

PyNN API was used to simulate SpiNNaker models (functionality built into SaRNN). The SpiNNaker neuron model has three differences from NL-IAF: (1) Neurons reset to zero after spiking instead of by subtraction; (2) spikes take one time step to traverse a synapse (e.g., rather than zero); and (3) neurons have a refractory period of one time step. These behaviors were implemented in the simulation, which can demonstrate that techniques described herein are generalizable to neuromorphic hardware, such as SpiNNaker.

TABLE 2 shows results for the dense MNIST model described above in connection with FIG. 8. Because of delays added for synaptic transmission and refractory periods, it takes some minimum amount of time (e.g., about 6 time steps) for a signal to propagate from the input to the output, which may have contributed to the smaller observed decrease in b_{L} compared to the results described in connection with FIGS. 10 and 11.

TABLE 2

| Metric | Before | After |
|---|---|---|
| max{aₜ} | 84.00% | 97.80% |
| b_{L} | 31.7 | 9.54 |
| b_{P} | 4.17e3 | 1.01e3 |

TABLE 2 includes results based on a simulation in which three refinement techniques described herein were applied to the dense MNIST model, and evaluated on SpiNNaker. Note that the PyNN simulation code used to perform the simulations did not support measuring synaptic events, so b_{L} is expressed in terms of spiking events.

In some embodiments, any suitable computer readable media can be used for storing instructions for performing the functions and/or processes described herein. For example, in some embodiments, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as RAM, Flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, or any suitable media that is fleeting and devoid of any semblance of permanence during transmission, and/or any suitable intangible media.

It should be noted that, as used herein, the term mechanism can encompass hardware, software, firmware, or any suitable combination thereof.

It should be understood that the above-described steps of the processes of FIGS. 5 and 6 can be executed or performed in any order or sequence not limited to the order and sequence shown and described in the figures. Also, some of the above steps of the processes of FIGS. 5 and 6 can be executed or performed substantially simultaneously where appropriate or in parallel to reduce latency and processing times.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

What is claimed is:

1. A method for using a spiking neural network with improved efficiency, the method comprising:
receiving image data;
providing the image data to a trained spiking neural network (SNN), the SNN comprising a plurality of neurons, each of the plurality of neurons associated with a respective initialization value V₀ of a plurality of initialization values,
wherein a first layer of the trained SNN comprises a first subset of the plurality of neurons, and a second layer of the trained SNN comprises a second subset of the plurality of neurons, and
wherein a mean of the plurality of initialization values is about 0.5, and a standard deviation of the initialization values is at least 0.05;
receiving output from the trained SNN at a time step τ,
wherein the output is based on activations of neurons in an output layer of the trained SNN, and
wherein τ is in a range of 1 to T; and
classifying the image data based on output of the trained SNN at time step τ.

2. A method for using a spiking neural network with improved efficiency, the method comprising:
receiving data;
providing the data to a trained spiking neural network (SNN), the SNN comprising a plurality of neurons, each of the plurality of neurons associated with a respective initialization value V₀ of a plurality of initialization values,
wherein a first layer of the trained SNN comprises a first subset of the plurality of neurons, and a second layer of the trained SNN comprises a second subset of the plurality of neurons, and
wherein a mean of the plurality of initialization values is about 0.5, and a standard deviation of the initialization values is at least 0.05;
receiving output from the trained SNN at a time step τ,
wherein the output is based on activations of neurons in an output layer of the trained SNN, and
wherein τ is in a range of 1 to T; and
performing a task associated with the data based on output of the trained SNN at time step τ.

3. The method of claim 2,
wherein the output is indicative of a neuron in the output layer that had the most activations up to time τ.

4. The method of claim 3,
wherein the data comprises image data,
wherein the task comprises a computer vision task that includes classification of the image data, and
wherein the neuron in the output layer that had the most activations up to time step τ corresponds to a first class of a plurality of classes.

5. The method of claim 2, further comprising:
receiving output from the trained SNN at a time step τ′ subsequent to time step τ; and
performing the task based on output of the trained SNN at step time τ′.

6. The method of claim 2, wherein data comprises image data comprising an array of pixels each associated with a value, and
providing the data to the trained SNN comprises:
generating, for each pixel, a spike train based on the value associated with the pixel, wherein spikes are generated at a rate that is proportional to the value associated with the pixel; and
providing, to each neuron of a plurality of neurons in an input layer of the trained SNN, a spike train associated with a respective pixel of the plurality of pixels.

7. The method of claim 2, wherein the data comprises image data comprising a plurality of spike streams generated by an imaging device.

8. The method of claim 7, wherein the imaging device comprises a light detection and ranging (LiDAR) device.

9. The method of claim 2, wherein the trained SNN was generated based on a trained analog neural network (ANN).

10. The method of claim 9, wherein the ANN was trained using a loss function L_{ANN} and the ANN was refined using a penalized loss function L′_{ANN} that included L_{ANN} and one or more penalized terms.

11. The method of claim 10, wherein the penalized loss function L′_{ANN} is represented by the relationship:
L′_{ANN}=L_{ANN}+λₐLₐ+λₛLₛ,
where Lₐ is an activation loss term based on β values associated with batch normalization layers of the trained ANN, Lₛ is a synaptic sparsity loss term based on weights of the trained ANN, and λₐ and λₛ are penalty values.

12. The method of claim 2, further comprising:
refining the trained SNN using a loss function L_{SNN}.

13. The method of claim 12, wherein the loss function L_{SNN} includes an accuracy term, a latency term, and a power consumption term.

14. The method of claim 13, wherein the loss function L_{SNN} is represented by the relationship:
L_{SNN}=λ_{M}M+λ_{L}b_{L}+λ_{P}b_{P},
where M is a minimum error 1−aₜ, aₜ represents an accuracy of the trained SNN at a particular time step, b_{L} represents a latency of the trained SNN, bₚ represents power consumption of the trained SNN, and λ_{M}, λ_{L}, and λ_{P} are penalty values.

15. The method of claim 12, wherein refining the SNN further comprises:
applying, to each of the plurality of neurons, a scaling factor ηⱼ, wherein H is a set of scaling factors for the plurality of neurons;
providing first labeled training data to the trained SNN;
receiving first output from the trained SNN for the first labeled training data;
calculating a first loss based on the first labeled training data and the first output from the trained SNN using the loss function L_{SNN};
adjusting values of the scaling factors in H based on the loss;
applying the adjusted scaling factors to the plurality of neurons of the trained SNN;
providing second labeled training data to the trained SNN;
receiving second output from the trained SNN for the second labeled training data; and
calculating a second loss based on the second labeled training data and the second output from the trained SNN using the loss function L_{SNN}.

16. The method of claim 12, wherein refining the SNN further comprises:
setting an initialization value V₀ for each of the plurality of neurons, wherein I includes a set of initialization values;
providing first labeled training data to the trained SNN;
receiving first output from the trained SNN for the first labeled training data;
calculating a first loss based on the first labeled training data and the first output from the trained SNN using the loss function L_{SNN};
adjusting values of the initialization values in I based on the loss;
applying the adjusted initialization values to the plurality of neurons of the trained SNN;
providing second labeled training data to the trained SNN;
receiving second output from the trained SNN for the second labeled training data; and
calculating a second loss based on the second labeled training data and the second output from the trained SNN using the loss function L_{SNN}.

17. The method of claim 2, wherein the ANN is a convolutional neural network (CNN).

18. The method of claim 2,
wherein an output Θ_{j,t} of a neuron j of the plurality of neurons is represented by the relationship:
$${Θ}_{j , t} = \{ \begin{matrix}1 & if {V}_{j , t} \geq 1 \\ 0 & else\end{matrix} ,$$
where j represents a neuron index, t represents a current time step, and V_{j,t} represents a neuron membrane potential at time step t, V_{j,0} is the initialization value of neuron j,
wherein the neuron membrane potential V_{j,t} of neuron j is represented by the relationship:
V_{j,t}=V_{j,t-1}−Θ_{j,t-1}+I_{j,t},
where I_{j,t} represents an incoming current at time t, and
the incoming current I_{j,t} is represented by the relationship:
I_{j,t}=s_{j,t}·wⱼ+bⱼ,
where s_{j,t} represents a binary-valued vector of incoming spikes at time step t, including one entry for each incoming synapse to neuron j, wⱼ represents a vector of synaptic weights associated with incoming synapses, and bⱼ represents a neuron bias of neuron j.

19. The method of claim 2, wherein the data comprises time-series data.

20. A system for using a spiking neural network with improved efficiency, the system comprising:
at least one processor that is configured to:
receive data;
provide the data to a trained spiking neural network (SNN), the SNN comprising a plurality of neurons, each of the plurality of neurons associated with a respective initialization value V₀ of a plurality of initialization values,
wherein a first layer of the trained SNN comprises a first subset of the plurality of neurons, and a second layer of the trained SNN comprises a second subset of the plurality of neurons, and
wherein a mean of the plurality of initialization values is about 0.5, and a standard deviation of the initialization values is at least 0.05;
receive output from the trained SNN at a time step t,
wherein the output is based on activations of neurons in an output layer of the trained SNN, and
wherein t is in a range of 1 to T; and
perform a task associated with the data based on output of the trained SNN at time step t.

21. The system of claim 20, wherein the at least one processor comprises a neuromorphic processor.

22. The system of claim 21, wherein the data comprises image data, the system further comprising:
an image data source in communication with the at least one processor, the image data source comprising an array of single-photon avalanche photodiodes (SPADs); and
wherein the at least one processor that is further configured to:
receive the image data from the image data source.
